(19) United States
(12) Patent Application Publication
(10) Pub. No.: US 2007/0064733 A1
(43) Pub. Date: Mar. 22, 2007

(54) Receiving device, electronic apparatus, communication method, communication program and recording medium

(75) Inventors: Shohei Osawa, Tenri-shi (JP); Hitoshi Naoe, Kitakatsuragi-gun (JP); Fumihiro Fukae, Sakurai-shi (JP); Koji Sakai, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/501,056

(22) Filed: Aug. 9, 2006

(30) Foreign Application Priority Data
Sep. 16, 2005 (JP) 2005-271223

(51) Int. Cl. H04J 3/22

(52) U.S. Cl. 370/468; 370/338

(57) ABSTRACT

A receiving device receives, using wireless communication, (i) a connect packet for establishing a communication connection (9,600 bps) and (ii) a data packet which contains transfer data and whose communication speed (for example, 4 Mbps) is higher than that of the connect packet. The receiving device includes: an error status judging section for judging, when a reception status satisfies a predetermined first reception failure pattern, that a reception of the connect packet has failed; and a cause-of-error output section for, when the reception failure of the connect packet has occurred, outputting cause information, indicating the cause of the reception failure, to a user interface. Therefore, even if an error has occurred in the data transfer, the user can easily recognize an appropriate solution for the receiving device.

This Nonprovisional application claims priority under 35 U.S.C. § 119 (a) on Patent Application No. 271223/2005 filed in Japan on Sep. 16, 2005, the entire contents of which are hereby incorporated by reference.

### FIELD OF THE INVENTION

The present invention relates to (I) a receiving device which receives, using wireless communication, from a transmitting device (i) a connect packet for establishing a communication connection and (ii) a data packet which contains transfer data and whose communication speed is higher than that of the connect packet, and (II) an electronic apparatus using this receiving device.

### BACKGROUND OF THE INVENTION

In recent years, due to the prevalence of devices, such as mobile telephones and digital cameras, the device is widely used for transferring recorded data to an electronic apparatus, such as a TV set and a printer.

One means for transferring data is an infrared method of IrDA (Infrared Data Association), etc. Information regarding IrDA is disclosed in, for example, Infrared Data Association Serial Infrared Physical Layer Specification Version 1.3 (Oct. 15, 1998). The infrared method of IrDA, etc. has directivity. Therefore, if there is a shielding between a transmitting device and a receiving device, it is impossible to carry out data transfer. Meanwhile, if there is nothing between the transmitting device and the receiving device, it is possible to carry out high-speed data transfer.

IrDA standard includes (i) Very Fast IR (VFIR) whose maximum transfer speed is 16 Mbps, (ii) Fast IR (FIR) whose maximum transfer speed is 4 Mbps, and (iii) SIR whose maximum transfer speed is 115.2 kbps. Currently available in the market is one whose maximum transfer speed is up to 4 Mbps.

Moreover, depending on the transmitting device and receiving device to be used, a communication distance is determined so as to be 20 cm or 100 cm.

An error rate defined in IrDA is 10⁻⁸. Therefore, in the case where there is nothing between the transmitting device and the receiving device, it is possible to carry out communication up to 100 cm and up to 4 Mbps. Moreover, even in the case of the occurrence of a communication error, retransmission is carried out. Therefore, it is possible to carry out high-speed data communication without a user becoming aware of the communication error.

Note that Japanese Unexamined Patent Publication No. 254941/1985 (Tokukaisho 60-254941 (published on Dec. 16, 1985)) discloses a data communication method whose transmission speed is variable.

Currently, IrDA is used for data transfer among PDAs, personal computers, and mobile telephones. However, these are used by a limited number of users. Moreover, devices supporting the communication distance of 20 cm are used so often. Therefore, the devices which carry out communication are extremely close to each other when used.

### SUMMARY OF THE INVENTION

However, it is anticipated that devices supporting the communication distance of 100 cm (or longer) will be widely used in future. In such a case, there is a strong possibility that communication is carried out by using substantially the limit of the communication distance. Moreover, because the communication distance is long, the communication is considerably affected by a directivity angle, optical noise, etc. In this case, an error frequently occurs during the data transfer. However, according to the conventional technology, in the case of the occurrence of such the error during the data transfer, a user who is not familiar with a communication system cannot deal with the error appropriately. Therefore, the data transfer error occurs frequently.

The present invention was made to solve the above-described problems, and an object of the present invention is to realize (i) a receiving device which allows a user to easily recognize an appropriate solution even if an error occurs during the data transfer, (ii) an electronic apparatus including this receiving device, (iii) a communication program containing functions of this receiving device, and (iv) a recording medium recording this communication program.

As described above, a receiving device of the present invention receives, using wireless communication, from a transmitting device (i) a connect packet for establishing a communication connection and (ii) a data packet which contains transfer data and whose communication speed is higher than that of the connect packet, and the receiving device includes: a first judging section for judging, when a reception status satisfies a predetermined first reception failure pattern, that a reception of the connect packet has failed; and a notice information output section for, when the first judging section judges that a reception failure has occurred, outputting notice information, for prompting a user to avoid the reception failure, to a user interface.

Moreover, a communication method of the present invention is used in a receiving device which receives, using wireless communication, from a transmitting device (i) a connect packet for establishing a communication connection and (ii) a data packet which contains transfer data and whose communication speed is higher than that of the connect packet, and the communication method includes the steps of: (i) judging by a first judging section of the receiving device, when a reception status satisfies a predetermined first reception failure pattern, that a reception of the connect packet has failed; and (ii) when the first judging section judges that the reception failure has occurred, outputting notice information, for prompting a user to avoid the reception failure, to a user interface by a notice information output section of the receiving device.

According to the above-described configuration, when the reception status satisfies the predetermined first reception failure pattern, the first judging section judges that the reception of the connect packet has failed. Then, when the first judging section judges that the reception failure has occurred, the notice information output section outputs to the user interface the notice information for prompting the user to avoid the reception failure.

Therefore, when the reception failure has occurred, the user can instantly recognize the notice information (for example, information indicating that the distance between the receiving device and the transmitting device is short) for prompting the user to avoid the reception failure. As a result, the user can carry out the data transfer again using an appropriate method for avoiding the reception failure. That is, it is possible to avoid the frequent occurrence of the data transfer error.

Moreover, a receiving device of the present invention receives, using wireless communication, from a transmitting device (i) a connect packet for establishing a communication connection and (ii) a data packet which contains transfer data and whose communication speed is higher than that of the connect packet, and the receiving device includes: a first judging section for judging, depending on whether or not a reception status satisfies a predetermined first reception failure pattern, whether a reception of the connect packet has succeeded or failed; a second judging section for judging, depending on whether or not the reception status satisfies a predetermined second reception failure pattern, whether a reception of the data packet has succeeded or failed; and a notice information output section for, when the first judging section judges that the reception of the connect packet has succeeded and the second judging section judges that the reception of the data packet has failed, outputting notice information, for prompting a user to avoid the reception failure of the data packet, to a user interface.

Moreover, a communication method of the present invention is used in a receiving device which receives, using wireless communication, from a transmitting device (i) a connect packet for establishing a communication connection and (ii) a data packet which contains transfer data and whose communication speed is higher than that of the connect packet, and the communication method includes the steps of: (i) judging by a first judging section of the receiving device, depending on whether or not a reception status satisfies a predetermined first reception failure pattern, whether a reception of the connect packet has succeeded or failed; (ii) judging by a second judging section of the receiving device, depending on whether or not the reception status satisfies a predetermined second reception failure pattern, whether a reception of the data packet has succeeded or failed; and (iii) when the first judging section judges that the reception of the connect packet has succeeded and the second judging section judges that the reception of the data packet has failed, outputting notice information, for prompting a user to avoid the reception failure of the data packet, to a user interface by a notice information output section of the receiving device.

According to the above-described configuration, when the first judging section judges that the reception of the connect packet has succeeded and the second judging section judges that the reception of data packet has failed, the notice information output section outputs to the user interface the notice information for prompting the user to avoid the reception failure of the data packet.

Therefore, when the reception of the connect packet has succeeded but the reception of the data packet has failed, the user can instantly recognize the notice information (for example, information indicating that “Outside a communicable area of the communication speed corresponding to the data packet”) for prompting the user to avoid the reception failure. As a result, the user can carry out the data transfer again using an appropriate method for avoiding the reception failure. That is, it is possible to avoid the frequent occurrence of the data transfer error.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing the configuration of a receiving device of Embodiment 1.

FIG. 2 is a configuration diagram showing a data transfer system including a mobile device and a display device that is an electronic apparatus.

FIG. 3 is a configuration diagram showing the data transfer system including the mobile device and a printing apparatus that is the electronic apparatus.

FIG. 4 is a configuration diagram showing the data transfer system including the mobile device and a recording apparatus that is the electronic apparatus.

FIG. 5 is a configuration diagram showing the data transfer system including the mobile device and a personal computer that is the electronic apparatus.

FIG. 6 is a configuration diagram showing the data transfer system including the mobile device and another mobile device that is the electronic apparatus.

FIG. 7 is a sequence diagram showing a data transfer method.

FIG. 8 is a block diagram showing the configuration of a transmitting device of Embodiment 1.

FIG. 9 is a diagram showing the frame structure of a connect packet.

FIG. 10 is a diagram showing the detailed frame structure of the connect packet.

FIG. 11 is a diagram showing the more detailed frame structure of the connect packet.

FIG. 12 is a diagram showing the frame structure of a data packet.

FIGS. 13(a) and 13(b) are diagrams each showing a sequence number field in the data packet.

FIG. 14 is a diagram showing one example of a first cause-of-error table stored in a cause-of-error table storing section.

FIG. 15 is a diagram showing one example of a second cause-of-error table stored in the cause-of-error table storing section.

FIG. 16 is a block diagram showing the internal configuration of an error status judging section included in the receiving device.

FIG. 17 is a flow chart showing the entire flow of a processing for the receiving device receiving a packet.

FIG. 18 is a flow chart showing the flow of a processing for detecting a reception error of the connect packet.

FIG. 19 is a flow chart showing the flow of a processing for generating a first error signal.

FIG. 20 is a flow chart showing the flow of a processing for detecting a reception error of the data packet.

FIG. 21 is a flow chart showing the flow of a processing for generating a second error signal.

FIG. 22 is a flow chart showing the flow of a processing for outputting cause information.

FIG. 23 is a flow chart showing a modification example of the processing for detecting the reception error of the connect packet.

FIG. 24 is a flow chart showing a modification example of the processing for generating the first error signal.

FIG. 25 is a diagram showing a modification example of the first cause-of-error table.

FIG. 26 is a flow chart showing a modification example of the processing for detecting the reception error of the data packet.

FIG. 27 is a flow chart showing a modification example of the processing for generating the second error signal.

FIG. 28 is a diagram showing a modification example of the second cause-of-error table.

FIG. 29 is a block diagram showing the configuration of the receiving device of Embodiment 2.

FIG. 30 is a diagram showing one example of information stored in a solution/cause storage section included in the receiving device of Embodiment 2.

FIG. 31 is a flow chart showing the flow of a processing, in Embodiment 2, for outputting solution information.

FIG. 32 is a block diagram showing the configuration of the receiving device of Embodiment 3.

FIG. 33 is a diagram showing one example of a first solution table stored in a solution table storing section included in the receiving device of Embodiment 3.

FIG. 34 is a diagram showing one example of a second solution table stored in the solution table storing section included in the receiving device of Embodiment 3.

FIG. 35 is a flow chart showing the flow of a processing, in Embodiment 3, for outputting the solution information.

### DESCRIPTION OF THE EMBODIMENTS

The following will explain embodiments of the present invention. Note that the following embodiments will explain, as an example, a transfer method (transmission method) in which data is transferred by infrared. However the present invention is not limited to this. For example, the present invention is applicable to optical transmission using light other than infrared, or other wireless communication method.

### Embodiment 1

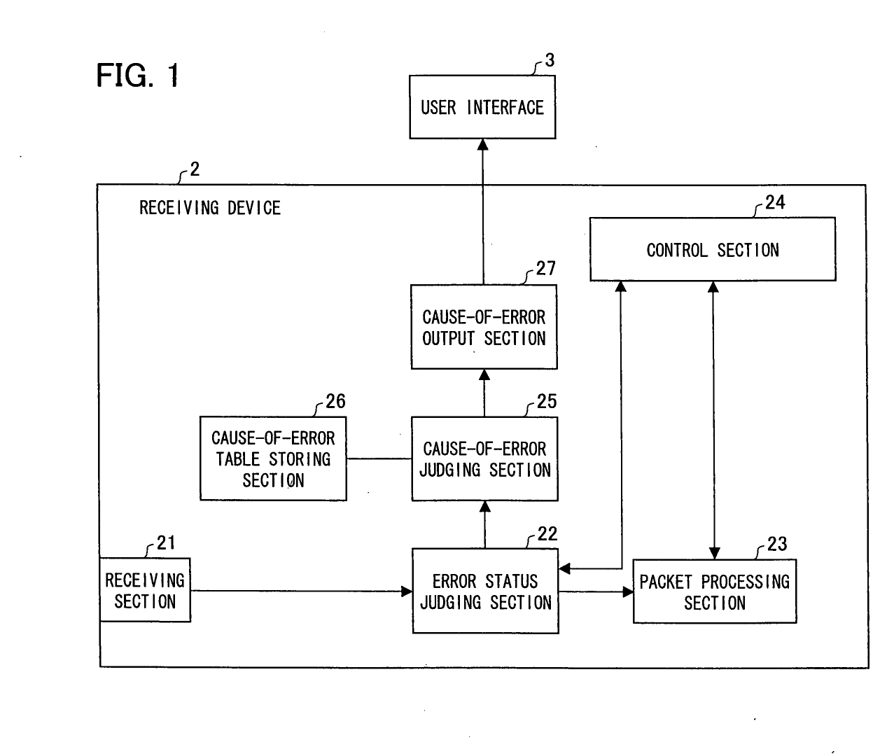

The following will explain Embodiment 1 of the present invention in reference to FIGS. 1 to 28.

As shown in FIG. 2, a data transfer system of the present embodiment includes (i) as a first device, a mobile device such as a mobile telephone and (ii) as a second device, an electronic apparatus such as a display device (for example, TV). The mobile device selects any file, such as a video file, image data, broadcast program information, and document data (hereinafter referred to as “data”), recorded in a recording medium of the mobile device, and transmits the selected file to an infrared interface of the electronic apparatus, whereas the electronic apparatus receives the data.

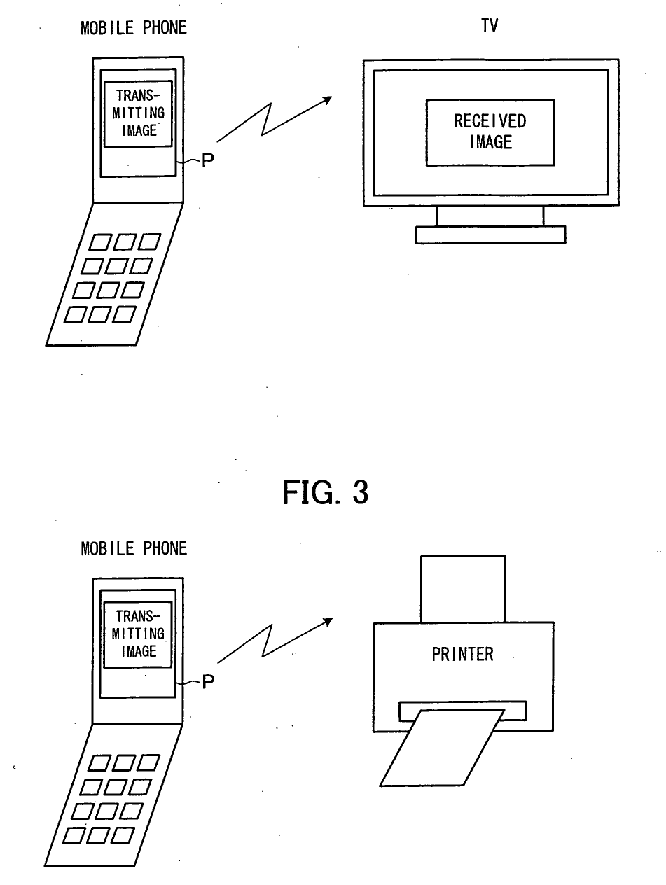

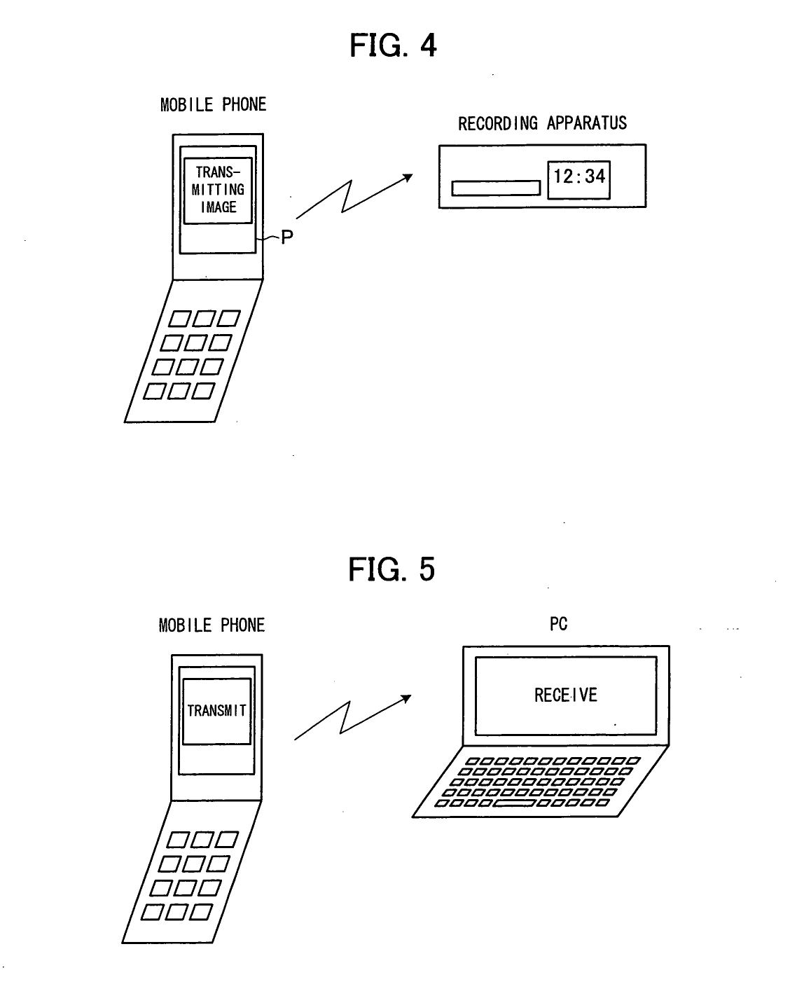

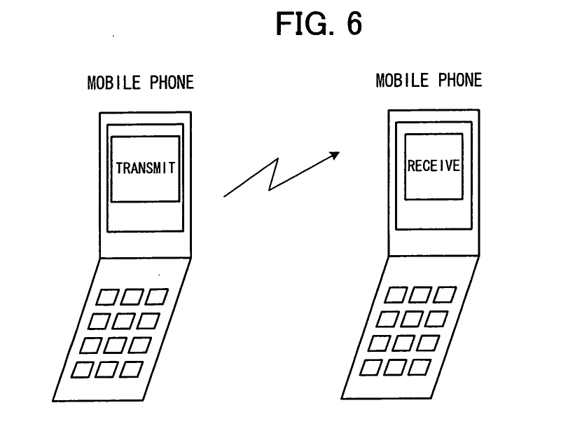

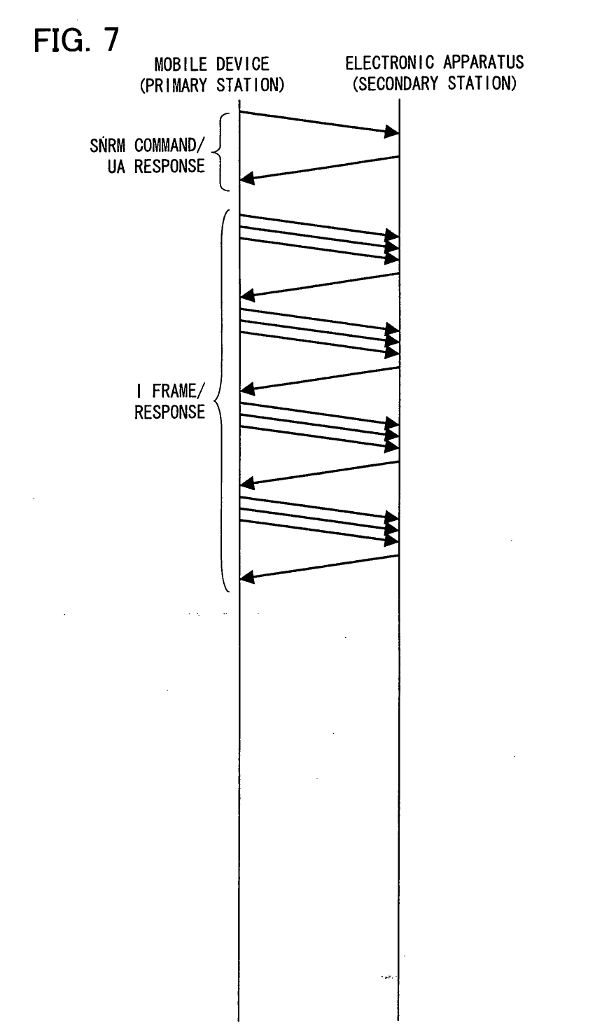

Note that the electronic apparatus is not limited to the display device, and may be, for example, a printing apparatus shown in FIG. 3, a recording apparatus (DVD (Digital Video Disk) recorder, CD (Compact Disk) recorder, HDD (Hard Disk Drive) recorder, VCR (Video cassette recorder)) shown in FIG. 4, a personal computer shown in FIG. 5, and another mobile device shown in FIG. 6 such as a mobile telephone having a recording medium. Moreover, the electronic apparatus may be a communication interface device (dongle) connected with the display apparatus, the printing apparatus, or the recording apparatus.

Moreover, the first device is the mobile device (for example, the mobile telephone) in the present embodiment, however the present embodiment is not limited to this. The first device may also be the electronic apparatus (the display apparatus, the printing apparatus, the recording apparatus, the personal computer, etc.) having the recording medium.

Referring to a sequence diagram shown in FIG. 7, the following will explain a data transfer processing between the mobile device and electronic apparatus of the present embodiment.

As shown in FIG. 7, in the present embodiment, instead of carrying out the packet switching of an XID command (command for finding a station) and a response, a user recognizes a receiving device and carries out transmission. In this way, for example, it is possible to decide an electronic apparatus that is a mate device communicating with the mobile device. That is, at the start of communication, (i) search for the mate device and (ii) the exchange of a command (connection command) necessary for establishing a connection with the mate device are carried out by the same connect packet (SNRM command in FIG. 7). In this way, it is possible to omit the packet switching of the command for finding the station, and also possible to shorten the time required for communication of file. Specifically, the time required for finding the station by IrDA protocol is usually 3 to 4 seconds, so that it is possible to reduce 3 to 4 seconds from the entire time required for communication of file.

Thus, in the case of only transmitting a file, it is possible to determine in advance a parameter(s) necessary for transmitting a file.

Specifically, a data size per frame, a maximum turnaround time, a minimum turnaround time, etc. are determined in advance. With this, the mobile device outputs a declared connect packet (connection packet) which describes only a parameter(s) changed from the predetermined value(s), the electronic apparatus recognizes the predetermined value(s) in the case where no descriptions are made in the connect packet, and the electronic apparatus transmits a response which describes the parameter(s) which has (have) been accepted by the electronic apparatus (the parameter(s) that the electronic apparatus has negotiated). Also, the electronic apparatus does not have to describe a parameter(s) in the response if the parameter is the same as the predetermined one. In the case where the response received by the mobile device has no description, the mobile device recognizes the predetermined value(s), and can carry out communication using the parameter(s) of the predetermined value(s).

Moreover, for example, the mobile device may output the connect packet containing a parameter indicating that the mobile device does not need the response from the electronic apparatus. In this case, the electronic apparatus which has received the connection command does not transmit a command response, but prepares for receiving data using the declared parameter(s).

Then, the mobile device transmits to the electronic apparatus the data packet (I frame) containing video data which is instructed to be transferred. Then, the electronic apparatus uses the parameter(s), set by the connect packet, so as to receive the data packet and carry out a predetermined processing (for example, a display processing) with respect to the data packet.

Configuration of Transmitting Device

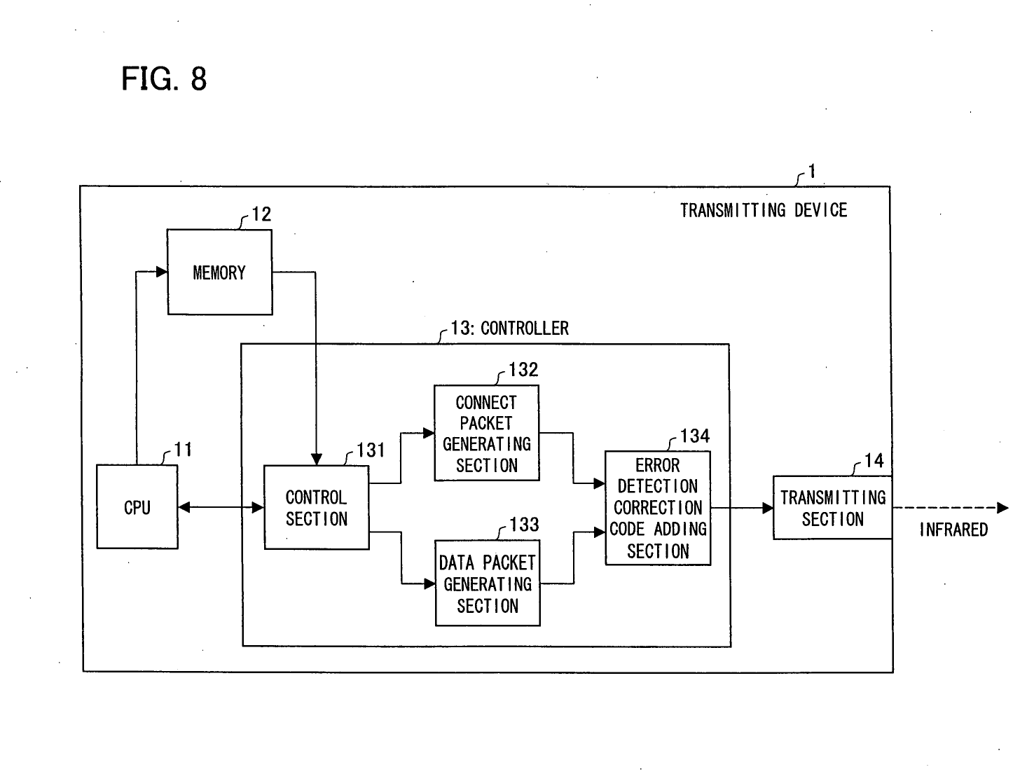

The following will explain the configuration of a transmitting device included in the mobile device. The transmitting device transmits the connect packet and the data packet. As shown in FIG. 8, a transmitting device 1 includes a CPU 11, a memory 12, a controller 13, and a transmitting section 14. Moreover, the controller 13 includes a control section 131, a connect packet generating section 132, a data packet generating section 133, and an error-detecting correction code adding section 134.

The CPU 11 carries out a predetermined computation in response to a user's instruction input to an operating section (not shown). One example of the predetermined computation is a transfer processing of transfer data. Upon receiving a transfer instruction of the transfer data from the operating section, the CPU 11 stores in the memory 12 the transfer data to be transferred, and carries out a transfer request to the control section 131. Moreover, upon receiving a transmission termination notice (indicating that transmission of the transfer data is terminated) from the control section 131, the CPU 11 completes the transfer processing.

The memory 12 stores the transfer data to be transmitted, and the CPU 11 writes the transfer data to the memory 12.

Upon receiving the transfer request from the CPU 11, the control section 131 causes the connect packet generating section 132 to generate the connect packet. Further, the control section 131 reads out the transfer data from the memory 12, transmits the read-out transfer data to the data packet generating section 133, and causes the data packet generating section 133 to generate the data packet. Here, the control section 131 controls a packet length and packet interval generated by the data packet generating section 133. Note that the control section 131 controls the packet length which is equal to or less than the maximum packet length obtained in accordance with data volume detected by the error-detecting correction code adding section 134 (will be described later). Moreover, the control section 131 controls the communication speed of the connect packet and the communication speed of the data packet.

Moreover, the control section 131 detects that all the data packets corresponding to the transfer data read out from the memory 12 have been transmitted from the transmitting section 14. Then, the control section 131 transmits to the CPU 11 the transmission termination notice indicating that the transmission of the transfer data is terminated.

The connect packet generating section 132 generates the connect packet containing a parameter(s) necessary for establishing a connection with the electronic apparatus that is a destination to which the data is transmitted. Here, the parameters necessary for establishing the connection are (i) a data transfer speed, (ii) a packet data size, (iii) a window size (the number of packets capable of being transmitted continuously), (iv) the maximum value and minimum value of a turnaround time (a time from a reception of data until a reply to the received data), (v) the number of Additional BOFs, and (vi) a time until a link is disconnected. Note that these are the parameters defined in a LAP layer among layers defined in an IrDA communication protocol. The connect packet generating section 132 of the present embodiment generates the connect packet necessary for establishing a connection of higher layers (LMP layer, TTP layer, OBEX layer) in addition to the LAP layer. The connect packet generating section 132 outputs the generated connect packet to the error-detecting correction code adding section 134.

Note that the transfer speed of the connect packet generated by the connect packet generating section 132 is controlled by the control section 131. In the present embodiment, the control section 131 controls the transfer speed of the connect packet so that the transfer speed is 9,600 bps.

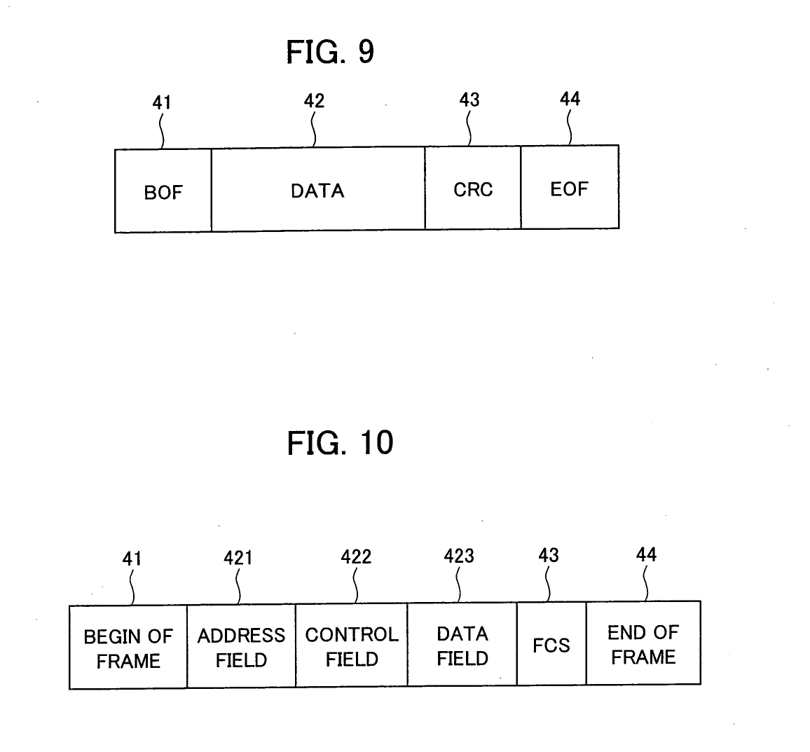

Here, as shown in FIG. 9, each connect packet contains a BOF (Begin Of Frame) 41, a DATA (data portion) 42, a CRC 43, and an EOF (End Of Frame) 44. The parameters necessary for establishing the connection are contained in the data portion 42.

The BOF 41 contains information indicating the beginning of a packet.

The DATA (data portion) 42 contains parameters for establishing a connection. As shown in FIG. 10, the DATA 42 contains an address field 421, a control field 422, and a data field 423. As will be described later, the CRC 43 contains an error-detecting code (or a correction code) (hereinafter may be referred to as “redundancy code”) and correction code added by the error-detecting correction code adding section 134. The EOF 44 contains information indicating the ending of a packet.

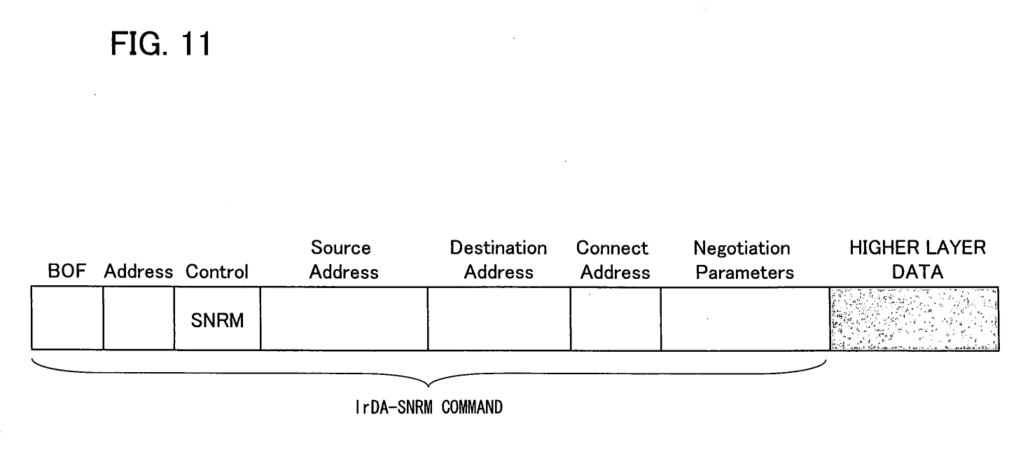

Moreover, as shown in FIG. 11, the connect packet contains an SNRM command of IrDA, and higher layer data necessary for establishing the connection of the higher layers.

The data packet generating section 133 divides the transfer data, received from the control section 131, so as to generate a plurality of data packets. Here, the data packet generating section 133 divides the transfer data so as to generate divided data (1) to (N) each of whose packet length is the packet length received from the control section 131. Then, the data packet generating section 133 generates the data packet containing each piece of divided data as information. That is, the data packet generating section 133 generates data packet (1) containing divided data (1), . . . , and data packet (N) containing divided data (N).

Note that the transfer speed of the data packet generated by the data packet generating section 133 is controlled by the control section 131. In the present embodiment, the control section 131 controls the transfer speed of the connect packet so that the transfer speed is 4 Mbps.

The data packet generating section 133 transmits a plurality of generated data packets to the error-detecting correction code adding section 134. Here, the data packet generating section 133 controls a time interval between respective data packets so that the time interval is the packet interval received from the control section 131.

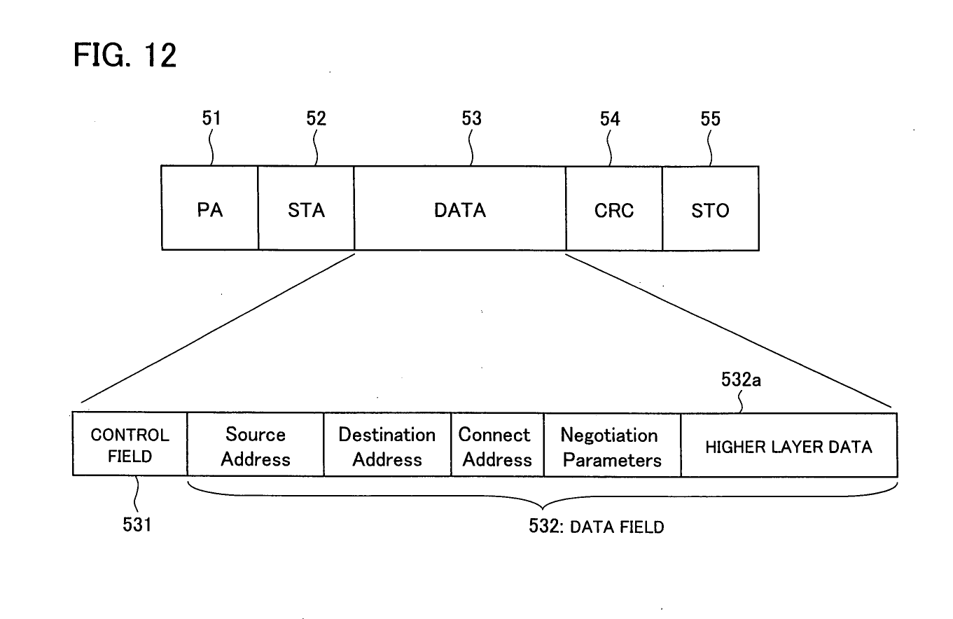

Here, as shown in FIG. 12, each data packet contains a preamble field (PA) 51, a start flag (STA) 52, DATA (data portion) 53 containing a control field 531 and a data field 532, a CRC 54, and a stop flag (STO) 55.

Moreover, a data field 532a contains a higher layer data 532a for the higher layers (which are an LMP layer, a TTP layer, and an OBEX layer in IrDA, and are an LMP layer, an SMP layer, and an OBEX layer in IrSimple). Note that the higher layer data 532a corresponding to a specific communication layer contains data corresponding to a communication layer immediately above the specific communication layer.

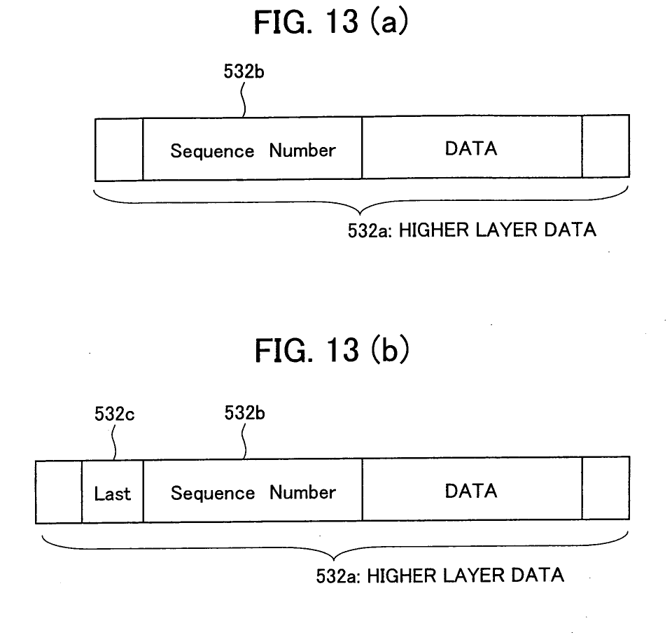

As shown in FIGS. 13(a) and 13(b), the higher layer data 532a contains, in a certain higher layer (for example, the SMP layer in IrSimple), (i) a sequence number field 532b indicating the sequence number that is the order of the divided data and (ii) a data field for a further higher layer(s). Note that the sequence number “0” that indicates the beginning is assigned to the first divided data (1). Moreover, the sequence numbers “1” to “N-2” are assigned to the divided data 2 to N-1, respectively.

Here, in the case where the higher layer data 532a has a field structure shown in FIG. 13(a), the sequence number “N” indicating the last data packet is assigned to the final divided data (last divided data).

Meanwhile, in the case where the higher layer data 532a has a field structure shown in FIG. 13(b), the flag of a Last field 532c indicating whether or not the divided data is the last one is “1” in the case of the final divided data (last divided data), and the flag of the Last field 532c is “0” in the case of the other divided data.

This allows the receiving device to confirm whether or not the last divided data has been received.

The error-detecting correction code adding section 134 adds the error-detecting code (or the correction code), for detecting an error, to the connect packet generated by the connect packet generating section 132 and the data packet generated by the data packet generating section 133. Then, the error-detecting correction code adding section 134 transmits those packets to the transmitting section 14. The error-detecting correction code adding section 134 adds the error-detecting code (or the correction code) to the CRC 43 of the connect packet and to the CRC 54 of the data packet.

Note that the error-detecting code is, for example, a cyclic code such as a CRC (Cyclic Redundancy Check) code, and the correction code is, for example, a BCH code such as a parity check code, a hamming code, and a reed solomon code. Note that the CRC code has a predetermined length. Depending on this length, the amount of data containing an error(s) to be detected by the CRC code is limited. Specifically, the CRC code has a length such as 16 bits and 32 bits. For example, the 16-bit CRC code can completely detect a 1-bit error(s) in data up to 2,048 bytes.

The transmitting section 14 transmits to an outside a plurality of packets, received from the controller 13, via an infrared communication path at predetermined time intervals.

As described above, the transmitting section 14 transmits the connect packet at the communication speed of 96,000 bps, and transmits the data packet at the communication speed of 4 Mbps which is higher than the communication speed of the connect packet.

Moreover, the transmitting section 14 transmits an Additional BOF before transmitting the connect packet, and transmits a pulse train, for synchronization, before transmitting the data packet. Note that the transmitting section 14 transmits the Additional BOF at the communication speed of 9,600 bps.

When the receiving device is in a power-saving mode, it sometimes cannot receive the BOF. However, since the Additional BOF is transmitted before the BOF, the receiving device can receive the BOF stably. That is, the Additional BOF is a pulse train for stabilizing the receiving device.

Configuration of Receiving Device

As shown in FIG. 1, the electronic apparatus which receives the connect packet and the data packet includes a receiving device 2 and a user interface 3.

The user interface 3 is, for example, a display section such as a liquid crystal display.

The receiving device 2 carries out a reception processing of the connect packet and the data packet. As shown in FIG. 1, the receiving device 2 includes a receiving section 21, an error status judging section (first judging means, second judging means) 22, a packet processing section 23, a control section 24, a cause-of-error judging section (notice information read-out means) 25, a cause-of-error table storing section (notice information table) 26, and a cause-of-error output section (notice information output means) 27.

The receiving section 21 receives the connect packet and the data packet transmitted from the mobile device.

Depending on whether or not a reception status satisfies a predetermined reception failure pattern, the error status judging section 22 judges that the reception of the connect packet (the data packet) has succeeded or failed. Then, the error status judging section 22 generates a first error signal indicating that the reception of the connect packet has succeeded or failed, and generates a second error signal indicating that the reception of the data packet has succeeded or failed. The error status judging section 22 outputs to the packet processing section 23 the connect packet and the data packet (i) from each of which the error is not detected by the error-detecting code (redundancy code) (or (ii) each of whose error rate is a predetermined threshold value or lower). Note that the detailed configuration of the error status judging section 22 will be described later.

Note that the error status judging section 22 generates the first error signal when the reception status satisfies the following first reception failure pattern.

(1) First Reception Failure Pattern Co1: A case where (i) three or more pulses corresponding to the communication speed of the connect packet have been received, but (ii) after the reception of these pulses, the higher layer(s) has not recognized, within a predetermined time, a parameter(s) indicated by the connect packet. The first error signal corresponding to this case is termed a first error signal <Co1>.

Note that the reason why there are three or more pulses is because, in the natural world, the probability of the same phenomenon occurring three times or more accidentally is extremely low.

(2) First Reception Failure Pattern Co2: A case where (i) three or more pulse trains of the Additional BOF transmitted before the connect packet have been received, but (ii) the specified number of Additional BOFs have not been received, or at least one of the BOF 41, the data portion 42, the CRC 43, and the EOF 44, which constitute the connect packet, has not been received. The first error signal corresponding to this case is termed a first error signal <Co2>.

(3) First Reception Failure Pattern Co3: A case where the connect packet has been received, but the reception status is such that an error is detected by the redundancy code. The first error signal corresponding to this case is termed a first error signal <Co3>.

When the connect packet is received normally, the error status judging section 22 generates a first error signal <Co0>.

Moreover, the error status judging section 22 generates the second error signal when the reception status satisfies the following second reception failure pattern.

(1) Second Reception Failure Pattern Da1: A case where three or more pulses corresponding to the communication speed of the data packet have been received, but at least one of (i) the specific pulse train for synchronization of the data packet, (ii) the STA 52, (ii) the data portion 53, (iii) the CRC 54, and (iv) the STO 55, (ii) to (iv) constituting the data packet, has not been received. The second error signal corresponding to this case is termed a second error signal <Da1>.

(2) Second Reception Failure Pattern Da2: A case where the data packet has been received, but the error rate is detected by the redundancy code so as to be equal to or higher than a predetermined threshold value. The second error signal corresponding to this case is termed a second error signal <Da2>.

(3) Second Reception Failure Pattern Da3: A case where the divided data corresponding to the sequence number “0” indicating the beginning is missing. The second error signal corresponding to this case is termed a second error signal <Da3>.

(4) Second Reception Failure Pattern Da4: A case where intermediate divided data (which are the divided data other than the first divided data and the last divided data) corresponding to discrete sequence numbers are missing. The second error signal corresponding to this case is termed a second error signal <Da4>.

(5) Second Reception Failure Pattern Da5: A case where a piece of intermediate divided data is missing, or the intermediate divided data corresponding to the consecutive sequence numbers are missing. The second error signal corresponding to this case is termed a second error signal <Da5>.

(6) Second Reception Failure Pattern Da6: A case where the divided data corresponding to the sequence number “N” indicating the ending is missing, or the divided data, whose one field indicating whether or not the divided data is the last one indicates that the divided data is the last one, is missing. The second error signal corresponding to this case is termed a second error signal <Da6>.

(7) Second Reception Failure Pattern Da7: A case where at lease two of the above-described Da3 to Da6 are occurring. The second error signal corresponding to this case is termed a second error signal <Da7>.

When all of a series of data packets are received normally, the error status judging section 22 generates a second error signal <Da0>.

The packet processing section 23 carries out a predetermined processing with respect to the connect packet and data packet received from the error status judging section 22. That is, the packet processing section 23 reads out a connection command from the data portion 42 of the connect packet, and outputs the read-out connection command to the control section 24.

Moreover, the packet processing section 23 reads out the data portion 53 (see FIG. 12) from the data packet, and outputs the read-out data portion 53 to the control section 24.

Here, the packet processing section 23 carries out the data processing of the PHY layer and LAP layer of IrDA, and sends data of the higher layer(s) to the control section 24.

The control section 24 carries out a predetermined processing corresponding to the connection command and data received from the packet processing section 23.

That is, the control section 24 causes the corresponding layers to recognize communication layer parameters contained in the connection command received from the packet processing section 23. Here, when all the communication layers have recognized the parameters, the control section 24 outputs to the error status judging section 22 a higher layer normal recognition notice indicating that all the communication layers have recognized the parameters.

Then, in accordance with the parameters indicated by the connection command, the control section 24 prepares for receiving data contained in the data packet.

Moreover, the control section 24 writes data, received from the packet processing section 23, to a memory (not shown), and transmits a reception completion notice to a CPU (not shown).

The control section 24 carries out a data processing of the higher layer(s) (which are the LMP layer, the TTP layer, and the OBEX layer in IrDA, and are the LMP layer, the SMP layer, and the OBEX layer in IrSimple).

Here, the control section 24 reads out the sequence numbers, corresponding to respective pieces of data, from the higher layer data 532a (see FIG. 12) of the data packet, and manages these sequence numbers. In the case where the higher layer data 532a has the field structure shown in FIG. 13(b), the control section 24 checks the flag of the Last field 532c, the flag indicating whether or not the data is the last one.

Then, (a) when data corresponding to the sequence number “0” indicating the beginning is missing, the control section 24 outputs to the error status judging section 22 a sequence number abnormal signal <Se1> indicating that the above data is missing, (b) when data corresponding to the discrete sequence numbers among data corresponding to the intermediate sequence numbers are missing, the control section 24 outputs to the error status judging section 22 a sequence number abnormal signal <Se2> indicating that the above data are missing, (c) when data corresponding to one sequence number among the data corresponding to the intermediate sequence numbers is missing, or data corresponding to the consecutive sequence numbers among the data corresponding to the intermediate sequence numbers are missing, the control section 24 outputs to the error status judging section 22 a sequence number abnormal signal <Se3> indicating that the above data is (are) missing, and (d) when data corresponding to the sequence number “N” indicating the ending is missing, or data corresponding to the flag (that is, the flag “1” of the Last field 532c shown in FIG. 13(b)) indicating the ending is missing, the control section 24 outputs to the error status judging section 22 a sequence number abnormal signal <Se4>.

The cause-of-error table storing section 26 stores (I) a first cause-of-error table which associates (i) the first error signals other than the first error signal <Co0> with (ii) respective pieces of cause information each indicating a cause corresponding to an error status indicated by each first error signal, and (II) a second cause-of-error table which associates, in the case of the first error signal <Co0>, (i) the second error signals with (ii) respective pieces of cause information each indicating the cause corresponding to the error status indicated by each second error signal.

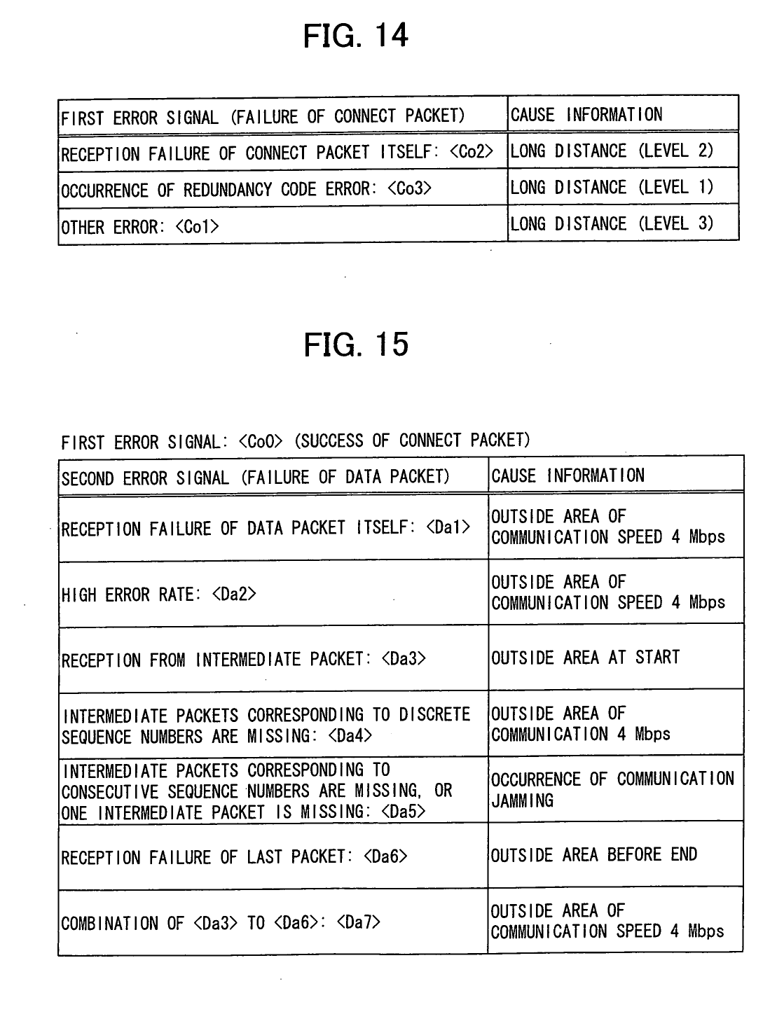

FIG. 14 is a diagram showing one example of the first cause-of-error table stored in the cause-of-error table storing section 26. As shown in FIG. 14, the first cause-of-error table associates each of the first error signals <Co1> to <Co3> with the cause information. Here, the first error signal <Co1> indicates the worst reception state, so that the first error signal <Co1> is associated with the cause information “Long distance (Level 3)”.

Similarly, the cause-of-error table storing section 26 stores the second cause-of-error table shown in FIG. 15.

The cause-of-error judging section 25 reads out from the cause-of-error table storing section 26 the cause information corresponding to the first error signal received from the error status judging section 22 and the cause information corresponding to the second error signal received from the error status judging section 22, and outputs these pieces of cause information to the cause-of-error output section 27.

Specifically, when the cause-of-error judging section 25 has received the first error signal other than the first error signal <Co0>, it reads out the cause information, corresponding to this first error signal, from the first cause-of-error table stored in the cause-of-error table storing section 26. Moreover, when the cause-of-error judging section 25 has received the first error signal <Co0> and the second error signal other than the second error signal <Da0>, it reads out the cause information, corresponding to this second error signal, from the second cause-of-error table stored in the cause-of-error table storing section 26. Then, the cause-of-error judging section 25 outputs the read-out cause information to the cause-of-error output section 27.

The cause-of-error output section 27 outputs to the user interface 3 the cause information received from the cause-of-error judging section 25, so as to inform the user of the cause of an error. For example, the cause-of-error output section 27 causes the display section that is the user interface 3 to display the cause information.

Configuration of Error Status Judging Section

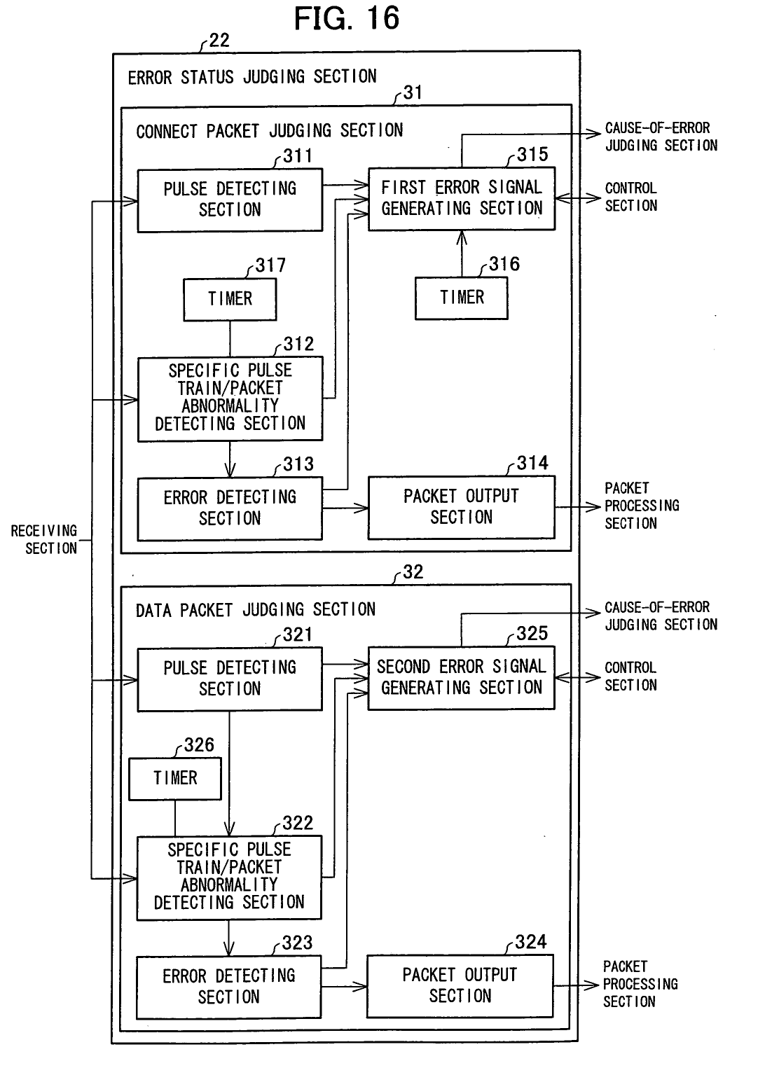

FIG. 16 is a block diagram showing the internal configuration of the error status judging section 22. The error status judging section 22 includes (i) a connect packet judging section (first judging means) 31 for judging a reception error status of the connect packet, and (ii) a data packet judging section (second judging means) 32 for judging the reception error status of the data packet.

Regarding Connect Packet Judging Section

The connect packet judging section 31 includes a pulse detecting section (first pulse detecting means) 311, a specific pulse train/packet abnormality detecting section (specific pulse train detecting means) 312, an error detecting section 313, a packet output section 314, a first error signal generating section 315, and timers 316 and 317.

When the pulse detecting section 311 has detected three or more pulses corresponding to 9,600 bps that is the communication speed of the connect packet, it outputs to the first error signal generating section 315 a pulse detecting signal indicating the above case.

When the specific pulse train/packet abnormality detecting section 312 has detected three specific pulse trains corresponding to the Additional BOF to be transmitted before the connect packet, it judges, within a predetermined time after the above detection, whether or not it has received (i) the specified number of Additional BOFs, (ii) the BOF 41, (iii) the data portion 42, (iv) the CRC 43, and (v) the EOF 44, (ii) to (v) constituting the connect packet (see FIG. 9). Note that the specific pulse train/packet abnormality detecting section 312 counts the above predetermined time with the timer 317.

When the specific pulse train/packet abnormality detecting section 312 does not receive, within a predetermined time, any of (i) the specified number of specific pulse trains, (ii) the BOF 41, (iii) the data portion 42, (iv) the CRC 43, and (v) the EOF 44, (ii) to (v) constituting the connect packet, it outputs to the first error signal generating section 315 a specific pulse train/packet abnormality detecting signal indicating the above case.

When the specific pulse train/packet abnormality detecting section 312 has received, within a predetermined time, the specified number of Additional BOFs, and all the fields constituting the connect packet, it outputs the received connect packet to the error detecting section 313.

The error detecting section 313 reads out the error-detecting code (redundancy code) from the CRC 43 of the connect packet, and detects, using the read-out redundancy code, an error(s) in the data portion 42 of the connect packet. When the error detecting section 313 has detected the error by the redundancy code, it outputs to the first error signal generating section 315 an error detecting signal indicating the above case. Moreover, the error detecting section 313 outputs to the packet output section 314 the connect packet received from the specific pulse train/packet abnormality detecting section 312.

When the error detecting section 313 has not detected the error in the connect packet, the packet output section 314 outputs this connect packet, received from the error detecting section 313, to the packet processing section 23. Meanwhile, when the error detecting section 313 has detected the error in the connect packet, the packet output section 314 discards this connect packet.

The first error signal generating section 315 generates the first error signal indicating the reception error status of the connect packet. As described above, in the present embodiment, there are the first error signals <Co0> to <Co3>.

As described above, the first error signal generating section 315 can receive (i) the pulse detecting signal from the pulse detecting section 311, (ii) the specific pulse train/packet abnormality detecting signal from the specific pulse train/packet abnormality detecting section 312, (iii) the error detecting signal from the error detecting section 313, and (iv) the higher layer normal recognition notice from the control section 24.

Upon receiving the pulse detecting signal from the pulse detecting section 311, the first error signal generating section 315 resets the timer 316, and judges, within a predetermined time, whether or not the higher layer normal recognition notice has been obtained from the control section 24. When the first error signal generating section 315 has obtained the higher layer normal recognition notice, it generates the first error signal <Co0> indicating that (i) the connect packet has been received normally and (ii) the higher layer(s) has recognized the connect packet.

Meanwhile, when the first error signal generating section 315 has not received the higher layer normal recognition notice within a predetermined time, it judges that the reception status has satisfied the first reception failure pattern Co1. Then, the first error signal generating section 315 generates the first error signal <Co1>.

Moreover, when the first error signal generating section 315 has received the specific pulse train/packet abnormality detecting signal from the specific pulse train/packet abnormality detecting section 312, it judges that the reception status has satisfied the first reception failure pattern Co2. Then, the first error signal generating section 315 generates the first error signal <Co2>.

Further, when the first error signal generating section 315 has received the error detecting signal from the error detecting section 313, it judges that the reception status has satisfied the first reception failure pattern Co3. Then, the first error signal generating section 315 generates the first error signal <Co3>.

Then, the first error signal generating section 315 outputs the generated first error signal to the cause-of-error judging section 25. When the first error signal generating section 315 has generated a plurality of first error signals, it determines the priority so that the first error signals <Co3>, <Co2>, and <Co1> are prioritized in this order from the higher priority signal to the lower priority signal, and outputs the higher (highest) priority first error signal. For example, when the first error signal generating section 315 has generated the first error signals <Co2> and <Co1>, it outputs the higher priority first error signal <Co2>.

Regarding Data Packet Judging Section

Next, the following will explain the data packet judging section 32. The data packet judging section 32 includes a pulse detecting section (second pulse detecting means) 321, a specific pulse train/packet abnormality detecting section 322, an error detecting section 323, a packet output section 324, a second error signal generating section 325, and a timer 326.

The pulse detecting section 321 detects a pulse whose frequency corresponds to the communication speed of 4 Mbps. When the pulse detecting section 321 has received three or more pulses described above, it outputs a pulse detecting signal to the second error signal generating section 325 and the specific pulse train/packet abnormality detecting section 322.

The specific pulse train/packet abnormality detecting section 322 judges whether or not it has received (i) the pulse train, corresponding to the data packet, for synchronization, (ii) the STA 52, (iii) the data portion 53, and (iv) the STO 55, (ii) to (iv) constituting the data packet (see FIG. 12).

Specifically, upon receiving the pulse detecting signal, the specific pulse train/packet abnormality detecting section 322 resets the timer 326, and judges, within a predetermined time, whether or not it has received (i) the pulse train for synchronization, (ii) the STA 52, (iii) the data portion 53, and (iv) the STO 55, (ii) to (iv) constituting the data packet (see FIG. 12). When the specific pulse train/packet abnormality detecting section 322 has not received these (i) to (iv), it outputs to the second error signal generating section 325 the specific pulse train/packet abnormality detecting signal indicating the above case. Meanwhile, when the specific pulse train/packet abnormality detecting section 322 has received these (i) to (iv), the specific pulse train/packet abnormality detecting section 325 outputs the received data packet to the error detecting section 323.

The error detecting section 323 calculates (guesses) the error rate of the transmitted data on the basis of the relationship between the error-detecting code contained in the CRC 54 of the data packet and the number of received packets.

For example, the error detecting section 323 calculates the error rate (=(the number of data packets in each of which an error(s) has been detected)/(the total number of bits)) on the basis of the number of data packets in each of which an error(s) has been detected by the error-detecting code and the total number of bits of received data.

Then, when the calculated error rate is higher than a predetermined threshold value, the error detecting section 323 outputs to the second error signal generating section 325 the error detecting signal indicating that the calculated error rate is higher than a predetermined threshold value. Moreover, the error detecting section 323 outputs to the packet output section 324 the data packet received from the specific pulse train/packet abnormality detecting section 322.

Here, when the error rate is 10⁻⁸ or higher, it is preferable that the error detecting section 323 output the error detecting signal. 10⁻⁸ is the error rate defined in IrDA, and with this error rate, communication of up to 100 cm and up to 4 Mbps can be carried out. With this, it is possible to properly judge whether or not an abnormality(s) of the data transfer has occurred.

When the error rate, calculated by the error detecting section 323, of the data packet is lower than the predetermined threshold value, the packet output section 324 outputs the data packet, received from the error detecting section 323, to the packet processing section 23. Meanwhile, when the error rate calculated by the error detecting section 323 is the predetermined threshold value or higher, the packet output section 324 discards this data packet.

The second error signal generating section 325 generates the second error signal indicating the reception error status of a series of data packets, and outputs the generated second error signal to the cause-of-error judging section 25.

Note that the second error signal generating section 325 can receive (i) the pulse detecting signal from the pulse detecting section 321, (ii) the specific pulse train/packet abnormality detecting signal from the specific pulse train/packet abnormality detecting section 322, (iii) the error detecting signal from the error detecting section 323, and (iv) the sequence number abnormal signal from the control section 24.

After obtaining the pulse detecting signal from the pulse detecting section 321, the second error signal generating section 325 starts the generation processing of the second error signal.

That is, when the second error signal generating section 325 has received the pulse detecting signal, and then has received the specific pulse train/packet abnormality detecting signal from the specific pulse train/packet abnormality detecting section 322, it judges that the reception status has satisfied the second reception failure pattern Da1. Then, the second error signal generating section 325 generates the second error signal <Da1>.

Moreover, when the second error signal generating section 325 has received the pulse detecting signal, and then has received the error detecting signal from the error detecting section 323, it judges that the reception status has satisfied the second reception failure pattern Da2. Then, the second error signal generating section 325 generates the second error signal <Da2>.

Moreover, when the second error signal generating section 325 has received the pulse detecting signal, and then has received the sequence number abnormal signal from the control section 24, it generates the second error signal corresponding to this sequence number abnormal signal.

Reception Processing of Connect Packet and Data Packet in Receiving Device

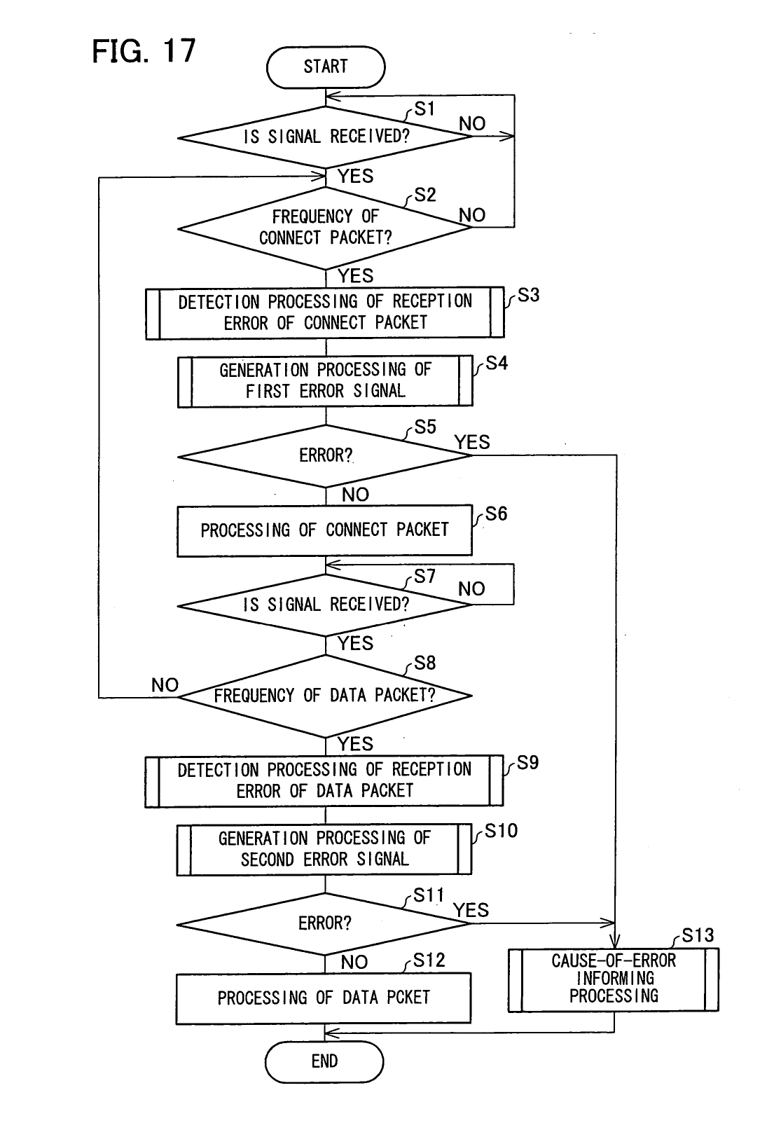

Next, referring to a flow chart of FIG. 17, the following will explain the entire flow of the reception processing of the connect packet and data packet in the receiving device 2.

First, the receiving section 21 judges whether or not a signal transmitted from the transmitting device 1 has been received (S1). When the receiving section 21 has not received the signal (No in S1), the processing returns to S1 again.

When the receiving section 21 has received the signal (Yes in S1), the pulse detecting section 311 of the connect packet judging section 31 judges whether or not the received signal contains three or more pulses whose frequency corresponds to the communication speed of the connect packet (S2).

When the received signal does not contain three or more pulses whose frequency corresponds to the communication speed of the connect packet (No in S2), the processing returns to S1.

Meanwhile, when the received signal contains three or more pulses whose frequency corresponds to the communication speed of the connect packet (Yes in S2), the specific pulse train/packet abnormality detecting section 312 and error detecting section 313 of the connect packet judging section 31 carries out a detection processing of a reception error regarding the connect packet (S3). Note that the flow of the detection processing of the reception error of the connect packet in S3 will be described later.

Then, the first error signal generating section 315 carries out the generation processing of the first error signal (S4). The generation processing of the first error signal will also be described later.

Here, when the first error signal indicates that some kind of reception error regarding the connect packet has occurred (Yes in S5), the processing proceeds to S13. Meanwhile, when the first error signal indicates that the reception error regarding the connect packet has not occurred (No in S5), the control section 24 prepares for receiving the data packet in accordance with a parameter(s) indicated by the received connect packet (S6).

Next, the receiving section 21 judges whether or not a signal transmitted from the transmitting device 1 has been received (S7). When the receiving section 21 has not received the signal (No in S7), the processing returns to S7 again.

When the receiving section 21 has received the signal (Yes in S7), the pulse detecting section 321 of the data packet judging section 32 judges whether or not the received signal contains three or more pulses whose frequency corresponds to the communication speed of the data packet (S8).

When the received signal does not contain three or more pulses whose frequency corresponds to the communication speed of the data packet (No in S8), the processing returns to S2.

Meanwhile, when the received signal contains three or more pulses whose frequency corresponds to the communication speed of the data packet (Yes in S8), the specific pulse train/packet abnormality detecting section 322 and error detecting section 323 of the data packet judging section 32 and the control section 24 carries out the detection processing of the reception error regarding the data packet (S9). Note that the flow of the detection processing of the reception error of the data packet in S9 will be described later.

Then, the second error signal generating section 325 carries out the generation processing of the second error signal (S10). The detail of the generation processing of the second error signal will also be described later.

Here, when the second error signal indicates that some kind of reception error regarding the data packet has occurred (Yes in S11), the processing proceeds to S13. Meanwhile, when the second error signal indicates that the reception error regarding the data packet has not occurred (No in S11), the control section 24 stores in a memory (not shown) data contained in the received data packet, and outputs the reception completion notice to a CPU (not shown). Then, the CPU carries out a predetermined processing with respect to the data contained in the data packet (S12).

Meanwhile, in S13, the cause-of-error judging section 25 and the cause-of-error output section 27 inform the user of the cause of an error. Note that the detail of S13 will be described later.

Detection Processing of Reception Error of Connect Packet

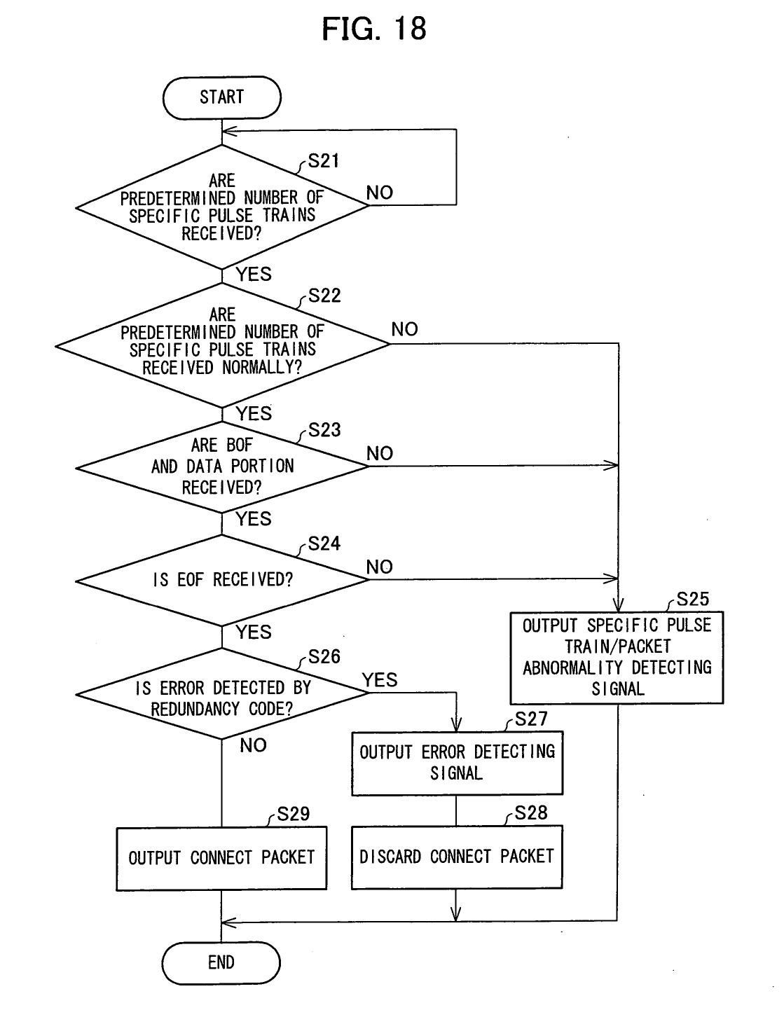

Next, referring to a flow chart of FIG. 18, the following will explain the flow of the detection processing, shown in S3, of the reception error of the connect packet.

First, the specific pulse train/packet abnormality detecting section 312 judges whether or not three or more pulse trains corresponding to the Additional BOF have been received (S21). When the specific pulse train/packet abnormality detecting section 312 has not received three or more pulse trains corresponding to the Additional BOF (No in S21), the processing repeats S21 again.

Meanwhile, when the specific pulse train/packet abnormality detecting section 312 has received three or more pulse trains corresponding to the Additional BOF (Yes in S21), it judges whether or not the specified number of Additional BOFs has been received (S22). Then, the specific pulse train/packet abnormality detecting section 312 judges whether or not it has received the BOF 41, the data portion 42, and the EOF 43, which constitute the connect packet (S23 and S24).

When the specific pulse train/packet abnormality detecting section 312 has not received the specified number of Additional BOFs (No in S22), or when the specific pulse train/packet abnormality detecting section 312 has not received at least one of the BOF 41, the data portion 42, and the EOF 43, which constitute the connect packet (No in S23 or S24), it generates the specific pulse train/packet abnormality detecting signal indicating that the reception failure of at least one of the Additional BOF, the BOF 41, the data portion 42, and the EOF 43 has occurred, and outputs the specific pulse train/packet abnormality detecting signal to the first error signal generating section 315 (S25). Then, the processing is terminated.

Meanwhile, when the specific pulse train/packet abnormality detecting section 312 has received all of the specified number of Additional BOFs, the BOF 41, the data portion 42, and the EOF 43 (Yes in S24), it outputs the received connect packet to the error detecting section 313. Then, the error detecting section 313 reads out the redundancy code from the CRC 43 of the connect packet, and judges, using the redundancy code, whether or not an error(s) is in the data portion 42 of the connect packet (S26).

When the error is detected by the redundancy code (Yes in S26), the error detecting section 313 outputs to the first error signal generating section 315 an error detecting signal indicating that the error is detected (S27). Then, the packet output section 314 discards the connect packet received from the error detecting section 313 (S28). Then, the processing is terminated.

Meanwhile, when the error has not been detected by the redundancy code (No in S26), the packet output section 314 outputs to the packet processing section 23 the connect packet received from the error detecting section 313 (S29). Then, the processing is terminated.

Generation Processing of First Error Signal

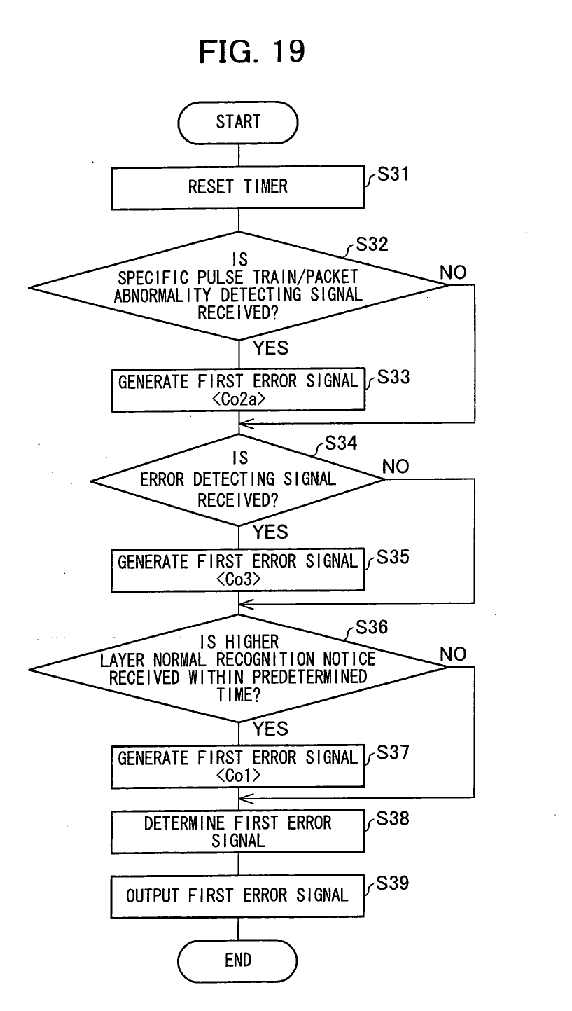

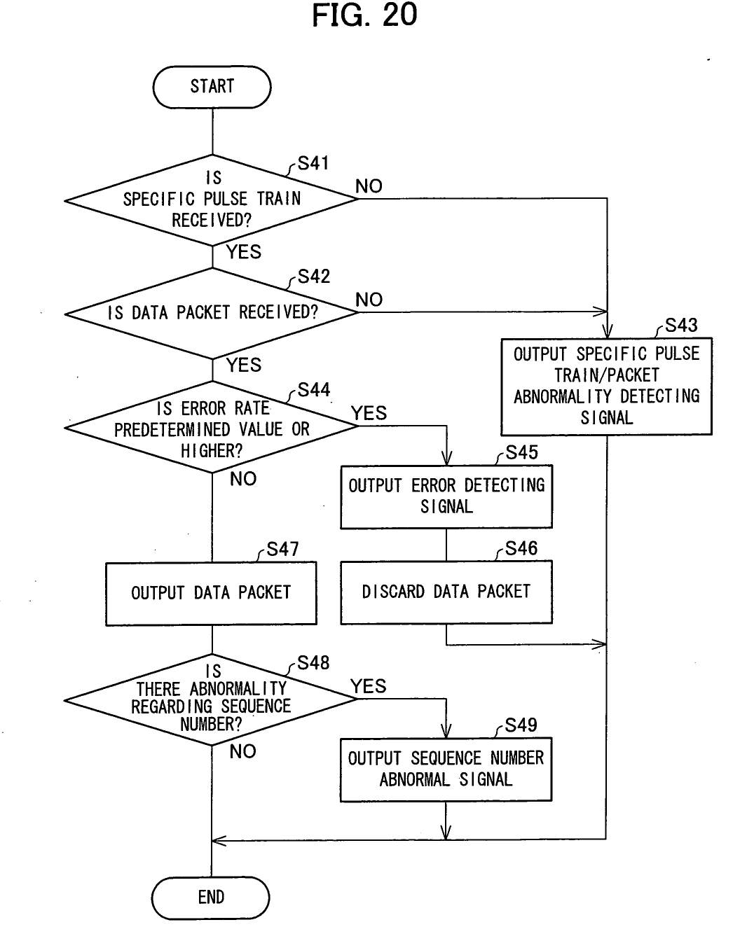

Next, referring to a flow chart of FIG. 19, the following will explain the flow of the generation processing, shown in S4, of the first error signal.

First, upon receiving the pulse detecting signal from the pulse detecting section 311, the first error signal generating section 315 resets the timer 316 (S31).

Then, the first error signal generating section 315 judges whether or not the specific pulse train/packet abnormality detecting signal has been received from the specific pulse train/packet abnormality detecting section 312 (S32).

When the first error signal generating section 315 has received the specific pulse train/packet abnormality detecting signal (Yes in S32), it judges that the reception status has satisfied the first reception failure pattern Co2. Then, the first error signal generating section 315 generates the first error signal <Co2> (S33). Then, the processing proceeds to S34. Meanwhile, when the first error signal generating section 315 has not received the specific pulse train/packet abnormality detecting signal (No in S32), again, the processing proceeds to S34.

Next, in S34, the first error signal generating section 315 judges whether or not the error detecting signal has been received from the error detecting section 313.

When the first error signal generating section 315 has received the error detecting signal (Yes in S34), it judges that the reception status has satisfied the first reception failure pattern Co3. Then, the first error signal generating section 315 generates the first error signal <Co3> (S35). Then, the processing proceeds to S36. Meanwhile, when the first error signal generating section 315 has not received the error detecting signal (No in S35), again, the processing proceeds to S36.

Next, in S36, within a predetermined time after the reception of the pulse detecting signal, the first error signal generating section 315 judges whether or not the higher layer normal recognition notice has been received from the control section 24.

When the first error signal generating section 315 has not received the higher layer normal recognition notice (No in S36), it judges that the reception status has satisfied the first reception failure pattern Co1. Then, the first error signal generating section 315 generates the first error signal <Co1> (S37a). Meanwhile, when the first error signal generating section 315 has received the higher layer normal recognition notice (Yes in S36), it generates the first error signal <Co0> (S37b).

Then, the first error signal generating section 315 determines the first error signal, to be output to the following section, from the generated first error signals (S38). That is, when the first error signal generating section 315 has generated only one first error signal, it determines to output this first error signal to the following section. Moreover, when the first error signal generating section 315 has generated a plurality of first error signals (in the present embodiment, there are two cases: one is the generation of the first error signals <Co1> and <Co2>; and another is the generation of the first error signals <Co1> and <Co3>), it determines the priority so that the first error signals <Co3>, <Co2>, and <Co1> are prioritized in this order from the higher priority signal, and determines to output the higher (highest) priority first error signal to the following section.

Then, the first error signal generating section 315 outputs to the cause-of-error judging section 25 the first error signal determined in S38 (S39).

Detection Processing of Reception Error of Data Packet

Next, referring to a flow chart of FIG. 20, the following will explain the flow of the detection processing, shown in S9, of the reception error of the data packet.

First, upon receiving the pulse detecting signal from the pulse detecting section 321, the specific pulse train/packet abnormality detecting section 322 resets the timer 326, and judges whether or not it has received, within a predetermined time after the reception of the pulse detecting signal, (i) the pulse train for synchronization of the data packet, (ii) the STA 52, (iii) the data portion 53, and (iv) the STO 55, (ii) to (iv) constituting the data packet (S41 and S42).

When the specific pulse train/packet abnormality detecting section 322 has not received at least one of (i) the pulse train for synchronization, (ii) the STA 52, (iii) the data portion 53, and (iv) the STO 55, (ii) to (iv) constituting the data packet (No in S41 or S42), it outputs to the second error signal generating section 325 the specific pulse train/packet abnormality detecting signal indicating that the reception failure of the pulse train for synchronization or the reception failure of the data packet has occurred (S43).

Meanwhile, when the specific pulse train/packet abnormality detecting section 322 has received all of (i) the pulse train for synchronization, (ii) the STA 52, (iii) the data portion 53, and (iv) the STO 55, (ii) to (iv) constituting the data packet (Yes in S42), it outputs the received data packet to the error detecting section 323. Then, the error detecting section 323 calculates the error rate of the transmitted data on the basis of the relationship between the error-detecting code contained in the CRC 54 of the data packet and the number of received data packets. Then, the error detecting section 323 judges whether or not the calculated error rate is a predetermined threshold value (which is 1×10⁻⁸ in this case) or higher (S44).

When the error rate is a predetermined threshold value or higher (Yes in S44), the error detecting section 323 outputs to the second error signal generating section 325 the error detecting signal indicating that the error rate is a predetermined threshold value or higher (S45). Then, the error detecting section 323 outputs to the packet output section 324 the data packet received from the specific pulse train/packet abnormality detecting section 322. Then, the packet output section 324 discards this data packet (S46). Then, the processing is terminated.

Meanwhile, when the error rate is lower than a predetermined threshold value (No in S44), the error detecting section 323 outputs to the packet output section 324 the data packet received from the specific pulse train/packet abnormality detecting section 322. Then, the packet output section 324 outputs to the packet processing section 23 the data packet received from the error detecting section 323 (S47).

Then, the packet processing section 23 extracts data from the data packet, and transmits the extracted data to the control section 24. Moreover, the control section 24 reads out the sequence number from the data received from the packet processing section 23, and manages the read-out sequence number. Then, the control section 24 judges whether or not there is an abnormality(s) regarding the sequence number (S48).

When there is the abnormality(s) regarding the sequence number (Yes in S48), the control section 24 generates the sequence number abnormal signal corresponding to this abnormality(s), and outputs the generated sequence number abnormal signal to the second error signal generating section 325 (S49). Then, the processing is terminated. Meanwhile, when there is no abnormality(s) regarding the sequence number (No in S48), again, the processing is terminated.

As described above, examples of the sequence number abnormal signal are (a) the sequence number abnormal signal <Se1> indicating that the data corresponding to the sequence number “0” indicating the beginning is missing, (b) the sequence number abnormal signal <Se2> indicating that the data corresponding to the discrete sequence numbers among the data corresponding to the intermediate sequence numbers are missing, (c) the sequence number abnormal signal <Se3> indicating that (i) the data corresponding to one sequence number among the data corresponding to the intermediate sequence numbers is missing, or (ii) the data corresponding to the consecutive sequence numbers among the data corresponding to the intermediate sequence numbers are missing, and (d) the sequence number abnormal signal <Se4> indicating that (i) the data corresponding to the sequence number “N” indicating the ending is missing, or (ii) the data corresponding to the flag (that is, the flag “1” of the Last field 532c) indicating the ending is missing.

Generation Processing of Second Error Signal

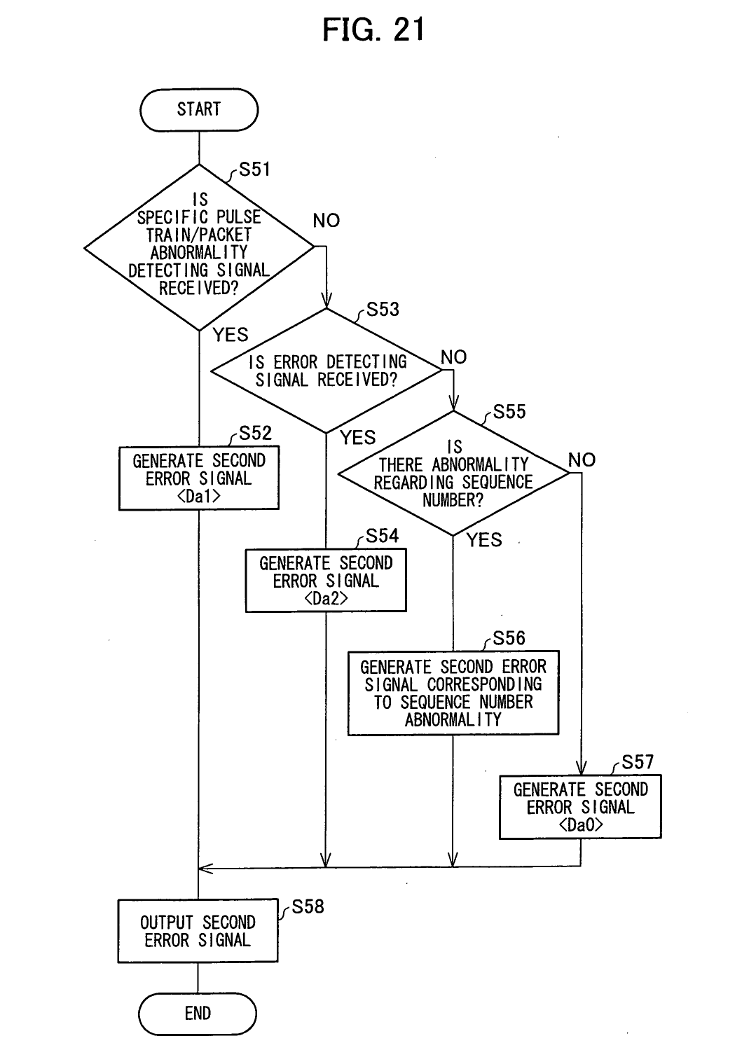

Next, referring to a flow chart of FIG. 21, the following will explain the flow of the generation processing, shown in S10, of the second error signal.

First, the second error signal generating section 325 which has received the pulse detecting signal from the pulse detecting section 321 judges whether or not the specific pulse train/packet abnormality detecting signal has been received from the specific pulse train/packet abnormality detecting section 322 (S51).

When the second error signal generating section 325 has received the specific pulse train/packet abnormality detecting signal (Yes in S51), it judges that the reception status has satisfied the second reception failure pattern Da1. Then, the second error signal generating section 325 generates the second error signal <Da1> (S52). Then, the processing proceeds to S58.

Meanwhile, when the second error signal generating section 325 has not received the specific pulse train/packet abnormality detecting signal (No in S52), it judges whether or not the error detecting signal has been received from the error detecting section 323 (S53).

When the second error signal generating section 325 has received the error detecting signal (Yes in S53), it judges that the reception status has satisfied the second reception failure pattern Da2. Then, the second error signal generating section 325 generates the second error signal <Da2> (S54). Then, the processing proceeds to S58.

Meanwhile, when the second error signal generating section 325 has not received the error detecting signal (No in S53), it judges whether or not the sequence number abnormal signal has been received from the control section 24 (S55).

When the second error signal generating section 325 has received the sequence number abnormal signal (Yes in S55), it generates the second error signal corresponding to this sequence number abnormal signal (S56).

That is, when the second error signal generating section 325 has received only the sequence number abnormal signal <Se1>, it judges that the reception status has satisfied the second reception failure pattern Da3. Then, the second error signal generating section 325 generates the second error signal <Da3>.

Moreover, when the second error signal generating section 325 has received only the sequence number abnormal signal <Se2>, it judges that the reception status has satisfied the second reception failure pattern Da4. Then, the second error signal generating section 325 generates the second error signal <Da4>.

Moreover, when the second error signal generating section 325 has received only the sequence number abnormal signal <Se3>, it judges that the reception status has satisfied the second reception failure pattern Da5. Then, the second error signal generating section 325 generates the second error signal <Da5>.

Moreover, when the second error signal generating section 325 has received only the sequence number abnormal signal <Se4>, it judges that the reception status has satisfied the second reception failure pattern Da6. Then, the second error signal generating section 325 generates the second error signal <Da6>.

Further, when the second error signal generating section 325 has received two or more of the sequence number abnormal signals <Se1> to <Se4>, it judges that the reception status has satisfied the second reception failure pattern Da7. Then, the second error signal generating section 325 generates the second error signal <Da7>.

Meanwhile, when the second error signal generating section 325 has not received the sequence number abnormal signal (No in S55), it generates the second error signal <Da0> indicating that the second error signal generating section 325 has received all of a series of data packets normally (S57).

Then, the second error signal generating section 325 outputs the generated second error signal to the cause-of-error judging section 25 (S58), and then terminates the processing.

Cause-of-Error Informing Processing

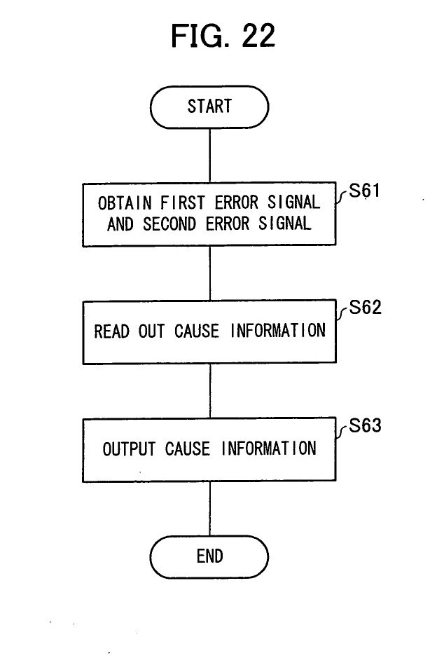

Next, referring to a flow chart of FIG. 22, the following will explain the flow of a cause-of-error informing processing shown in S13.

First, the cause-of-error judging section 25 receives the first error signal and the second error signal from the error status judging section 22 (S61).

Next, the cause-of-error judging section 25 reads out from the cause-of-error table storing section 26 the cause information corresponding to the first error signal and the second error signal (S62).

Specifically, when the cause-of-error judging section 25 has received the first error signal other than the first error signal <Co0>, it reads out the cause information, corresponding to this first error signal, from the first cause-of-error table stored in the cause-of-error table storing section 26. Moreover, when the cause-of-error judging section 25 has received the first error signal <Co0> and the second error signal other than the second error signal <Da0>, it reads out the cause information, corresponding to this second error signal, from the second cause-of-error table stored in the cause-of-error table storing section 26.

Then, the cause-of-error judging section 25 outputs the read-out cause information to the cause-of-error output section 27. Then, the cause-of-error output section 27 outputs the cause information, received from the cause-of-error judging section 25, to the user interface 3, so as to inform the user of the cause of an error (S63).

For example, when the cause-of-error judging section 25 has received the first error signal <Co1>, it reads out the cause information “Long distance (Level 3)” from the first cause-of-error table shown in FIG. 14. Then, the cause-of-error output section 27 causes the user interface 3 to display this cause information. With this, when the receiving device 2 has received three or more pulse trains corresponding to the communication speed of the connect packet, but the higher layer(s) has not recognized the connect packet normally, the user can recognize that the distance between the receiving device 2 and the transmitting device 1 needs to be shortened.

Moreover, when the cause-of-error judging section 25 has received the first error signal <Co2>, it reads out the cause information “Long distance (Level 2)” from the first cause-of-error table shown in FIG. 14. Then, the cause-of-error output section 27 causes the user interface 3 to display this cause information. With this, when the receiving device 2 has received three or more pulse trains corresponding to the Additional BOF, but has not received the connect packet, the user can recognize that the distance between the receiving device 2 and the transmitting device 1 needs to be shortened.

Moreover, when the cause-of-error judging section 25 has received the first error signal <Co3>, it reads out the cause information “Long distance (Level 1)” from the first cause-of-error table shown in FIG. 14. Then, the cause-of-error output section 27 causes the user interface 3 to display this cause information. With this, when the error of the connect packet has been detected by the redundancy code, the user can recognize that the distance between the receiving device 2 and the transmitting device 1 needs to be shortened.

Moreover, when the cause-of-error judging section 25 has received the first error signal <Co0> and the second error signal <Da1> (or <Da2>, <Da4>, or <Da7>), it reads out the cause information “Outside the area of the communication speed 4 Mbps” from the second cause-of-error table shown in FIG. 15. Then, the cause-of-error output section 27 causes the user interface 3 to display this cause information. With this, the user can recognize that the distance between the receiving device 2 and the transmitting device 1 needs to be shortened. As a result, it is possible to carry out the data transfer normally.

Moreover, when the cause-of-error judging section 25 has received the first error signal <Co0> and the second error signal <Da3>, it reads out the cause information “Outside the area at the start” from the second cause-of-error table shown in FIG. 15. Then, the cause-of-error output section 27 causes the user interface 3 to display this cause information. With this, the user can recognize that (i) the error has occurred only at the start of transmission of data from the transmitting device 1, and (ii) the data transfer can be carried out normally by retransmitting the data from a current location.

Moreover, when the cause-of-error judging section 25 has received the first error signal <Co0> and the second error signal <Da5>, it reads out the cause information “Occurrence of communication jamming” from the second cause-of-error table shown in FIG. 15. Then, the cause-of-error output section 27 causes the user interface 3 to display this cause information. With this, the user can recognize that some kind of communication jamming has occurred when transmitting data from the transmitting device 1. Therefore, upon confirming the existence of the communication jamming, the user can carry out retransmission. As a result, it is possible to carry out the data transfer normally.

Here, examples of the communication jamming are a radio signal having strong electric power or an optical signal which are not related to the communication between the transmitting device 1 and the receiving device 2, a barrier between the transmitting device 1 and the receiving device 2, etc.

Moreover, when the cause-of-error judging section 25 has received the first error signal <Co0> and the second error signal <Da6>, it reads out the cause information “Outside the area before the end of transmission” from the second cause-of-error table shown in FIG. 15. Then, the cause-of-error output section 27 causes the user interface 3 to display this cause information. With this, the user can recognize that the transmitting device has been outside the area at the end of transmission of data. Therefore, the user can retransmit the data without changing the location of the transmitting device 1 until the completion of reception. As a result, it is possible to carry out the data transfer normally.

### MODIFICATION EXAMPLES

### Modification Example 1

### Regarding Detection Processing of Reception Error of Connect Packet and Generation Processing of First Error Signal

According to the foregoing explanation, the specific pulse train/packet abnormality detecting section 312 detects only whether or not the data portion 42 of the connect packet has been received. However, the specific pulse train/packet abnormality detecting section 312 may instantly analyze the data portion 42 of the connect packet whose communication speed is low, so as to judge whether or not the data portion 42 contains a parameter(s) necessary for establishing a connection.

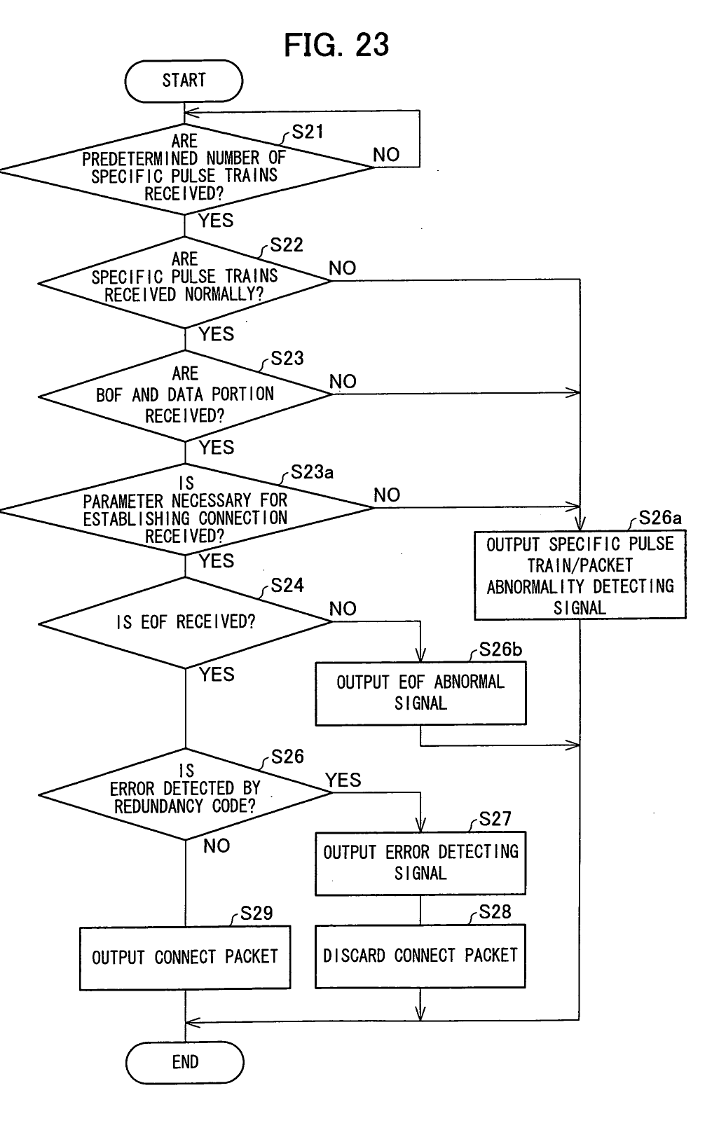

The flow of the detection processing of the reception error of the connect packet in the present modification example is shown in a flow chart of FIG. 23.

First, the specific pulse train/packet abnormality detecting section 312 judges whether or not three or more pulse trains corresponding to the Additional BOF have been received (S21). When the specific pulse train/packet abnormality detecting section 312 has not received three or more pulse trains corresponding to the Additional BOF (No in S21), the processing repeats S21 again.

Meanwhile, when the specific pulse train/packet abnormality detecting section 312 detects that three or more pulse trains corresponding to the Additional BOF have been received (Yes in S21), it judges whether or not it has received (i) the specified number of Additional BOFs, (ii) the BOF 41 and (iii) the data portion 42, (ii) and (iii) constituting the connect packet (S22 and S23). Further, the specific pulse train/packet abnormality detecting section 312 analyzes the data portion 42 of the received connect packet, so as to judge whether or not the data portion 42 contains the parameter(s) necessary for establishing the connection (S23a).

When the specific pulse train/packet abnormality detecting section 312 has not received at least one of the specified number of Additional BOFs, the BOF 41, and the data portion 42 (No in S22 or S23), or when the data portion 42 does not contain the parameter(s) necessary for establishing the connection (No in S23a), the specific pulse train/packet abnormality detecting section 312 generates the specific pulse train/packet abnormality detecting signal indicating that the reception failure of the connect packet has occurred, and outputs the generated signal to the first error signal generating section 315 (S26a). Then, the processing is terminated.

Meanwhile, when the specific pulse train/packet abnormality detecting section 312 has received the specified number of Additional BOFs, the BOF 41, and the data portion 42, and the data portion 42 contains the parameter(s) necessary for establishing the connection (Yes in S23a), it then judges whether or not the EOF 44 has been received (S24).

When the specific pulse train/packet abnormality detecting section 312 has failed to receive the EOF 44 (No in S24), it outputs to the first error signal generating section 315 an EOF reception abnormal signal indicating that the specific pulse train/packet abnormality detecting section 312 has received the parameter(s) necessary for establishing the connection but has not received the connect packet normally (S26b). Then, the processing is terminated.

Then, S26 to S29 shown in FIG. 18 are carried out.

Meanwhile, when the first error signal generating section 315 has received the specific pulse train/packet abnormality detecting signal, it judges that the reception status has satisfied the first reception failure pattern Co2a indicating that the specific pulse train/packet abnormality detecting section 312 has failed to receive any of the Additional BOF, the BOF 41, and the data portion 42. Then, the first error signal generating section 315 generates the first error signal <Co2a>. Moreover, when the first error signal generating section 315 has received the EOF reception abnormal signal, it judges that the reception status has satisfied the first reception failure pattern Co2b indicating that the specific pulse train/packet abnormality detecting section 312 has received the parameter(s) necessary for establishing the connection but has not received the connect packet normally. Then, the first error signal generating section 315 generates the first error signal <Co2b>.

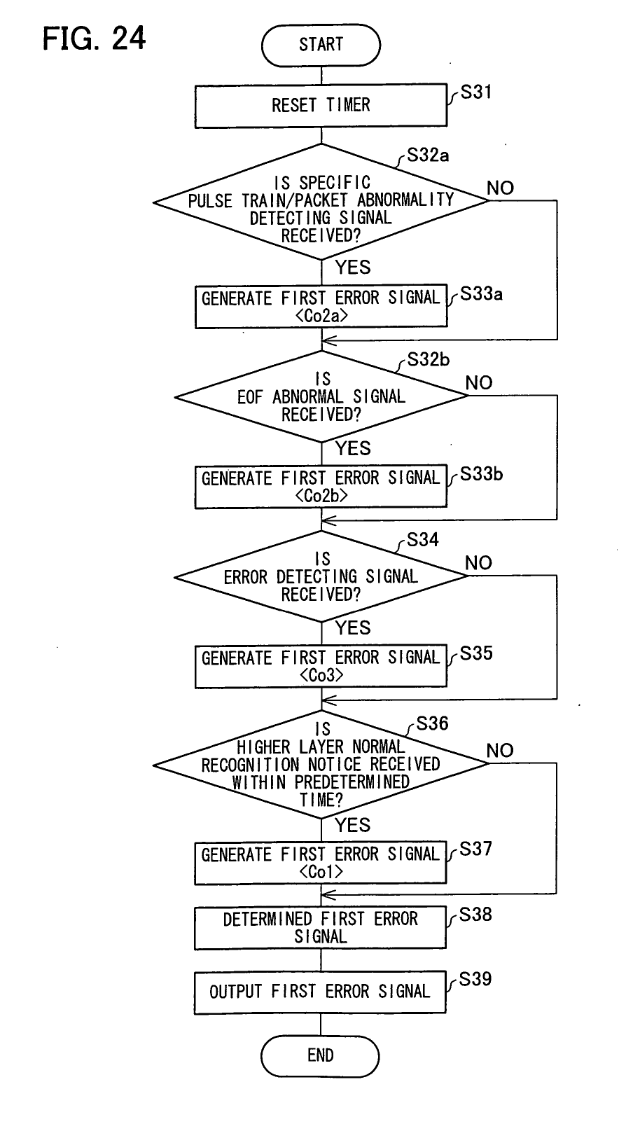

The flow of the generation processing of the first error signal in the present modification example is shown in a flow chart of FIG. 24.

First, upon receiving the pulse detecting signal from the pulse detecting section 311, the first error signal generating section 315 resets the timer 316 (S31).

Then, the first error signal generating section 315 judges whether or not the specific pulse train/packet abnormality detecting signal has been received from the specific pulse train/packet abnormality detecting section 312 (S32a).

When the first error signal generating section 315 has received the specific pulse train/packet abnormality detecting signal (Yes in S32a), it generates the first error signal <Co2a> (S33a). Then, the processing proceeds to S32b. Meanwhile, when the first error signal generating section 315 has not received the specific pulse train/packet abnormality detecting signal (No in S32a), again, the processing proceeds to S32b.

Next, the first error signal generating section 315 judges whether or not the EOF reception abnormal signal has been received from the specific pulse train/packet abnormality detecting section 312 (S32b).

When the first error signal generating section 315 has received the EOF reception abnormal signal (Yes in S32b), it generates the first error signal <Co2b> (S33b). Then, the processing proceeds to S34. Meanwhile, when the first error signal generating section 315 has not received the EOF reception abnormal signal (No in S32b), again, the processing proceeds to S34.

Then, S34 to S39 shown in FIG. 19 are carried out. In S38, when the first error signal generating section 315 has generated a plurality of first error signals, it determines the priority so that the first error signals <Co3>, <Co2b>, <Co2a>, and <Co1> are prioritized in this order from the higher priority signal, and determines to output the higher (highest) priority first error signal.

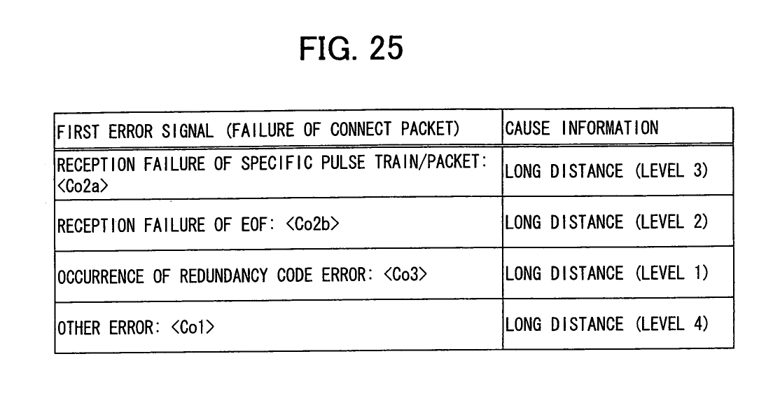

Note that in the present modification example, the cause-of-error table storing section 26 stores the first cause-of-error table of FIG. 25.

With this, when the cause-of-error judging section 25 has received the first error signal <Co2b>, it reads out the cause information “Long distance (Level 2)” from the first cause-of-error table of FIG. 25. Then, the cause-of-error output section 27 causes the user interface 3 to display this cause information. With this, the user can recognize that it is necessary that the user be close to the receiving device 2 and then carry out retransmission. As a result, it is possible to carry out the data transfer normally.

### Modification Example 2

### Regarding Detection Processing of Reception Error of Connect Packet and Generation Processing of First Error Signal

In the foregoing explanation, the first error signal generating section 315 can generate plural kinds of first error signals. However, the first error signal generating section 315 may be able to generate only one of the first error signals other than the first error signal <Co0> indicating that the reception error of the connect packet has not occurred. That is, the first error signal generating section 315 can generate only one of the first error signals <Co1>, <Co2>, <Co2a>, <Co2b>, and <Co3>.

For example, when the first error signal generating section 315 can generate only the first error-signal <Co1>, it may only have to receive only the pulse detecting signal from the pulse detecting section 311 and the higher layer normal recognition notice from the control section 24. Then, when the first error signal generating section 315 has received the pulse detecting signal, and then has not received, within a predetermined time, the higher layer normal recognition notice, it generates the first error signal, and outputs the generated signal to the cause-of-error output section 27.

Moreover, when the first error signal generating section 315 can generate only the first error signal <Co2>, it may only have to receive only the pulse detecting signal from the pulse detecting section 311 and the specific pulse train/packet abnormality detecting signal from the specific pulse train/packet abnormality detecting section 322. Then, when the first error signal generating section 315 has received the pulse detecting signal, and then has received the specific pulse train/packet abnormality detecting signal, it generates the first error signal, and outputs the generated signal to the cause-of-error output section 27.

Moreover, when the first error signal generating section 315 can generate only the first error signal <Co3>, it may only have to receive only the pulse detecting signal from the pulse detecting section 311 and the error detecting signal from the error detecting section 323. Then, when the first error signal generating section 315 has received the pulse detecting signal, and then has received the error detecting signal, it generates the first error signal, and outputs the generated signal to the cause-of-error output section 27.

Moreover, in this case, the cause-of-error table storing section 26 may only have to store a predetermined piece of first cause information (for example, “Long distance”), instead of the first cause-of-error table. Then, when the cause-of-error judging section 25 has received the first error signal, it may only have to read out the first cause information from the cause-of-error table storing section 26, and output this first cause information to the cause-of-error output section 27. That is, when the cause-of-error judging section 25 and the cause-of-error output section 27 have received the first error signal (other than the first error signal <Co0>), they output a predetermined piece of first cause information (for example, “Long distance”) to the user interface 3.

### Modification Example 1

### Regarding Detection Processing of Reception Error of Data Packet and Generation Processing of Second Error Signal

After the pulse detecting section (communication speed detecting means) 321 has received the connect packet normally, it may detect the communication speed of the data packet. Then, when the pulse detecting section 321 has detected a pulse whose communication speed is higher than that of the data packet indicated by the connect packet, it outputs a communication speed error detecting signal to the second error signal generating section 325. In this case, the control section 24 informs the pulse detecting section 321 of the communication speed indicated by the connect packet.

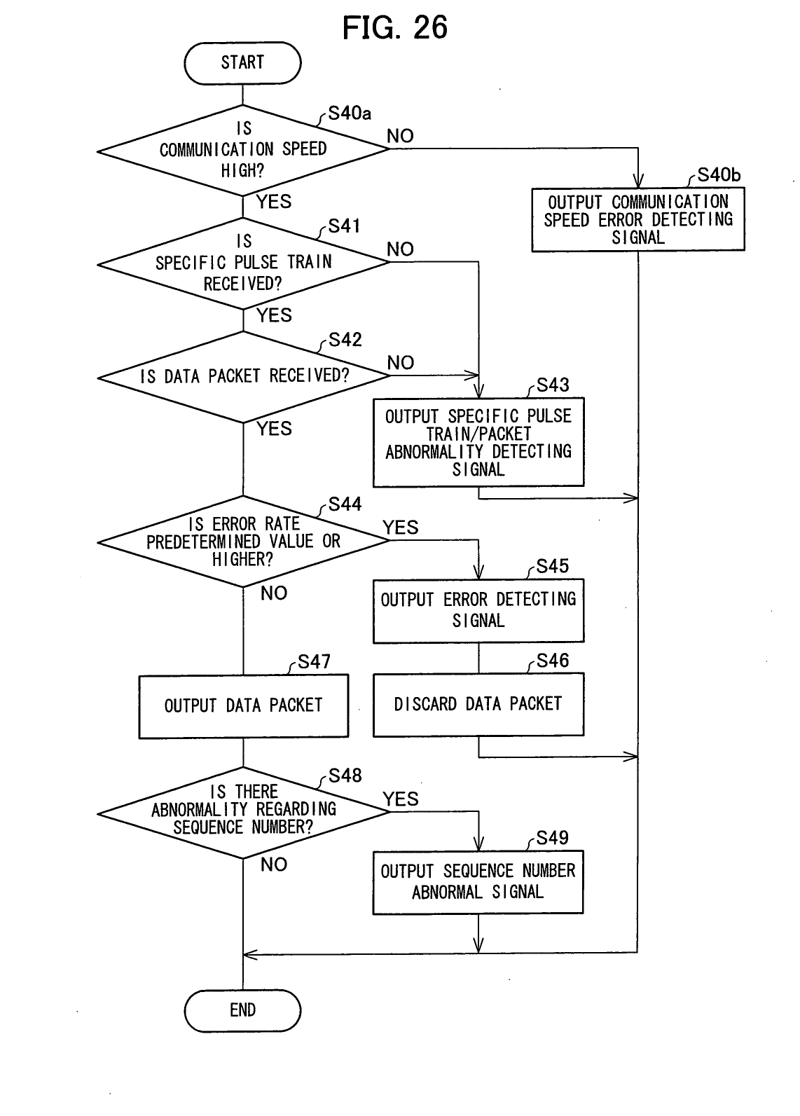

The detection processing of the reception error of the data packet in the present modification example is shown in a flow chart of FIG. 26. That is, S40a and S40b are added to the flow chart of FIG. 20.

First, the pulse detecting section 321 judges whether or not a pulse, whose communication speed is higher than that of the data packet indicated by the connect packet, has been detected (S40a).

When the pulse detecting section 321 has detected the pulse whose communication speed is higher than that of the data packet indicated by the connect packet (Yes in S40a), it outputs to the second error signal generating section 325 the communication speed error detecting signal indicating that the pulse detecting section 321 has detected such the pulse (S40b). Then, the processing is terminated.

Meanwhile, when the pulse detecting section 321 has detected the pulse whose communication speed is equal to or lower than that of the data packet indicated by the connect packet (No in S40a), S41 to S49 shown in FIG. 20 are carried out. Then, the processing is terminated.

Moreover, when the second error signal generating section 325 has received the communication speed error detecting signal, it judges that the reception status has satisfied the second reception failure pattern Da8 indicating that the pulse detecting section 321 has received the data packet whose communication speed is higher than the communication speed indicated by the connect packet. Then, the second error signal generating section 325 generates the second error signal <Da8>.

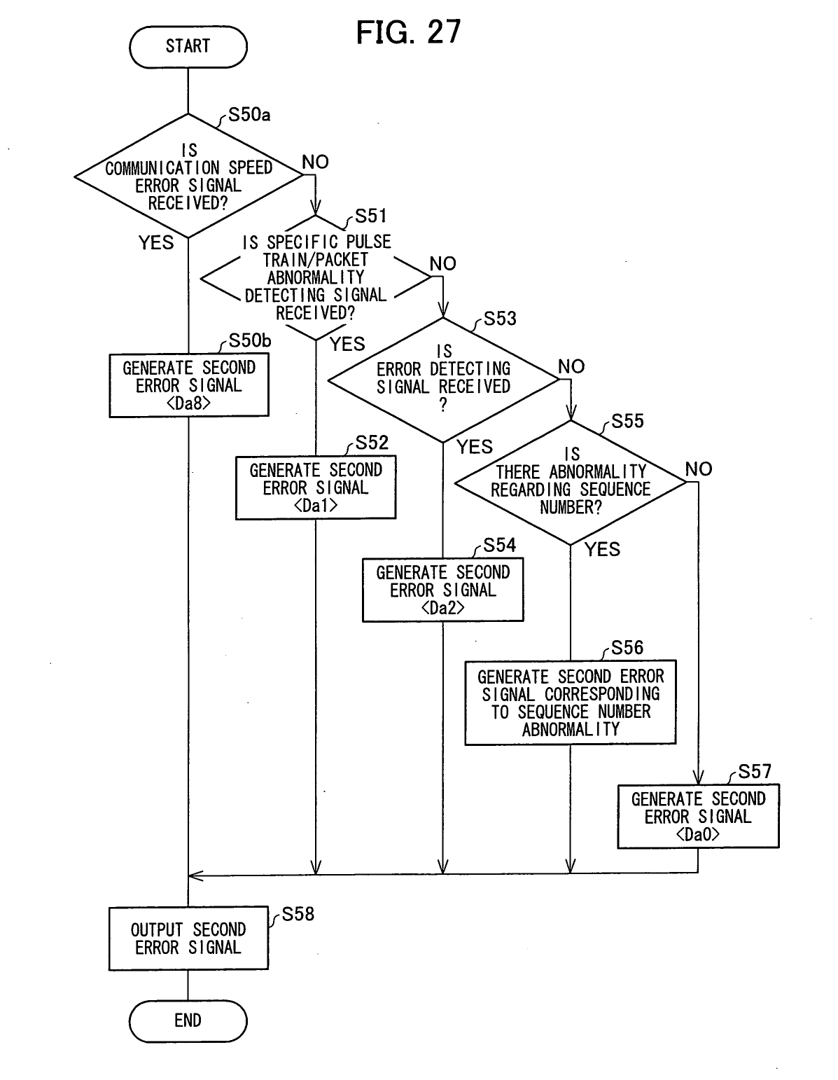

That is, the second error signal generating section 325 of the present modification example may only have to generate the second error signal in accordance with a flow chart of FIG. 27.

First, the second error signal generating section 325 judges whether or not the communication speed error detecting signal has been received from the pulse detecting section 321 (S50a).

When the second error signal generating section 325 has received the communication speed error detecting signal (Yes in S50a), it generates the second error signal <Da8> indicating that the data packet whose communication speed is high has been received (S50b). Then, in S58, the second error signal generating section 325 outputs the generated second error signal to the cause-of-error judging section 25.

Meanwhile, when the second error signal generating section 325 has not received the communication speed error detecting signal (No in S50a), it carries out S51 to S58 of FIG. 21. Then, the processing is terminated.

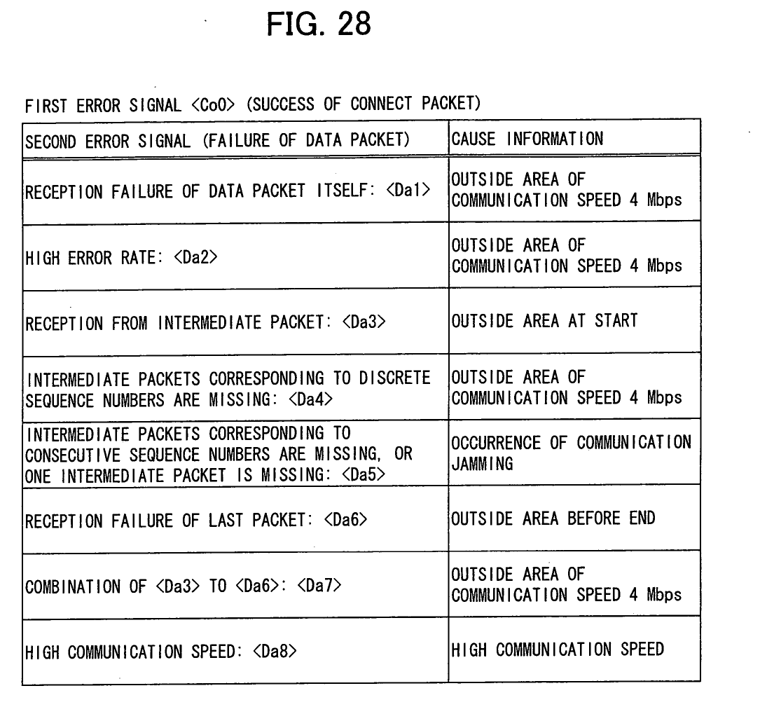

Note that in the present modification example, the cause-of-error table storing section 26 may only have to store the second cause-of-error table of FIG. 28.

According to the present modification example, when transmitted is the data packet whose communication speed is higher than the communication speed specified by the connect packet, the second error signal generating section 325 outputs the second error signal <Da8> indicating that the data packet whose communication speed is high has been received. Then, the cause-of-error judging section 25 reads out from the cause-of-error table storing section 26 the cause information “High communication speed” corresponding to the second error signal <Da8>, and the cause-of-error output section 27 outputs this cause information to the user interface 3.

As a result, by carrying out retransmission at a lower communication speed, the user can carry out the data transfer normally.

### Modification Example 2

### Regarding Detection Processing of Reception Error of Data Packet and Generation Processing of Second Error Signal

In the foregoing explanation, the second error signal generating section 325 can generate plural kinds of second error signals. However, the second error signal generating section 325 may be able to generate only one kind of second error signal. That is, the second error signal generating section 325 can generate only one of the second error signals <Da1> to <Da8>.

For example, when the second error signal generating section 325 can generate only the second error signal <Da1>, it may only have to receive only the pulse detecting signal from the pulse detecting section 321 and the specific pulse train/packet abnormality detecting signal from the specific pulse train/packet abnormality detecting section 322. Then, when the second error signal generating section 325 has received the pulse detecting signal, and then has received the specific pulse train/packet abnormality detecting signal, it generates the second error signal, and outputs the generated signal to the cause-of-error output section 27.

In this case, the cause-of-error table storing section 26 may only have to store second cause information “Outside the area of the communication speed 4 Mbps”, instead of the second cause-of-error table. Then, when the cause-of-error judging section 25 has received the first error signal <Co0> and the second error signal, it may only have to read out the second cause information from the cause-of-error table storing section 26, and output this second cause information to the cause-of-error output section 27.

Moreover, when the second error signal generating section 325 can generate only the second error signal <Da2>, it may only have to receive only the pulse detecting signal from the pulse detecting section 321 and the error detecting signal from the error detecting section 323. Then, when the second error signal generating section 325 has received the pulse detecting signal, and then has received the error detecting signal, it generates the second error signal, and outputs the generated signal to the cause-of-error output section 27.

In this case, the cause-of-error table storing section 26 may only have to store the second cause information “Outside the area of the communication speed 4 Mbps”, instead of the second cause-of-error table. Then, when the cause-of-error judging section 25 has received the first error signal <Co0> and the second error signal, it may only have to read out the second cause information from the cause-of-error table storing section 26, and output this second cause information to the cause-of-error output section 27.

Moreover, when the second error signal generating section 325 can generate only the second error signal <Da3>, it may only have to receive only the pulse detecting signal from the pulse detecting section 321 and the sequence number abnormal signal <Se1> from the control section 24. Then, when the second error signal generating section 325 has received the pulse detecting signal, and then has received the sequence number abnormal signal, it generates the second error signal, and outputs the generated signal to the cause-of-error output section 27.

In this case, the cause-of-error table storing section 26 may only have to store the second cause information “Outside the area at the start”, instead of the second cause-of-error table. Then, when the cause-of-error judging section 25 has received the first error signal <Co0> and the second error signal, it may only have to read out the second cause information from the cause-of-error table storing section 26, and output this second cause information to the cause-of-error output section 27.

The same is true for a case where the second error signal generating section 325 can generate only the second error signal <Da4>, <Da5>, <Da6>, or <Da7>.

Moreover, when the second error signal generating section 325 can generate only the second error signal <Da8>, it may only have to receive only the communication speed error detecting signal from the pulse detecting section 321. Then, when the second error signal generating section 325 has received the communication speed error detecting signal, it generates the second error signal, and outputs the generated signal to the cause-of-error output section 27.

In this case, the cause-of-error table storing section 26 may only have to store the second cause information “High communication speed”, instead of the second cause-of-error table. Then, when the cause-of-error judging section 25 has received the first error signal <Co0> and the second error signal, it may only have to read out the second cause information from the cause-of-error table storing section 26, and output this second cause information to the cause-of-error output section 27.

### Modification Example Regarding User Interface

In the foregoing explanation, the user interface 3 is the display section (for example, a message display device) such as a liquid crystal display. However, the present invention is not limited to this. The user interface 3 may be anything as long as it can inform the user of the cause information.

For example, the cause information that is audio data may be output to the user interface 3 that is a speaker.

Moreover, the user interface 3 may be a light emitting element(s) (LED(s)). By turning on/off or blinking the LEDs so that the LEDs form a certain pattern(s), it is possible to inform the user of the cause information.

Moreover, in order to get the user to properly transmit the infrared, whose directivity angle is not wide, toward the receiving section 21, the electronic apparatus may include receiving section location informing means for informing the user of the location of the receiving section 21 that is an infrared receiving section. One example of the receiving section location informing means is an LED which is added to the vicinity of the receiving section 21 so as not to disturb the communication.

Moreover, especially in the case where the electronic apparatus is an image forming apparatus, a display screen of the image displaying apparatus may achieve a display indicating the receiving section 21. For example, the display screen may display an arrow indicating the receiving section 21.

### Modification Example Regarding Cause Information

In the foregoing explanation, the cause-of-error table storing section 26 associates each of the first error signals <Co1> to <Co3> with the cause information “Long distance”, and stores the first error signals <Co1> to <Co3> and the cause information “Long distance”. However, one reason why the reception error of the connect packet occurs may be that the transmitting device 1 is outside a communicable angular range of the receiving device 2. Therefore, the cause-of-error table storing section 26 may associate each of the first error signals <Co1> to <Co3> with the cause information “Outside the communicable angular range” or the cause information “Long distance or Outside the communicable angular range”, and store the first error signals <Co1> to <Co3>, and the cause information “Outside the communicable angular range” and/or the cause information “Long distance or Outside the communicable angular range”.

Similarly, the cause-of-error table storing section 26 may associate each of the second error signals <Da1>, <Da2>, <Da4>, and <Da7> with the cause information “Outside the communicable angular range” or the cause information “Outside the area of the communication speed 4 Mbps or Outside the communicable angular range”, and store the second error signals <Da1>, <Da2>, <Da4>, and <Da7>, and the cause information “Outside the communicable angular range”, and/or the cause information “Outside the area of the communication speed 4 Mbps or Outside the communicable angular range”.

Moreover, the cause-of-error table storing section 26 may associate the second error signal <Da3> with the cause information “Outside the communicable angular range at the start” or the cause information “Outside the area of the communication speed 4 Mbps at the start or Outside the communicable angular range”, and store the second error signal <Da3>, and the cause information “Outside the communicable angular range at the start” or the cause information “Outside the area of the communication speed 4 Mbps at the start or Outside the communicable angular range”.

Further, the cause-of-error table storing section 26 may associate the second error signal <Da6> with the cause information “Outside the communicable angular range before the end of transmission” or the cause information “Outside the area of the communication speed 4 Mbps before the end of transmission or Outside the communicable angular range before the end of transmission”, and store the second error signal <Da6>, and the cause information “Outside the communicable angular range before the end of transmission” or the cause information “Outside the area of the communication speed 4 Mbps before the end of transmission or Outside the communicable angular range before the end of transmission”.

As above, the receiving device 2 of the present embodiment receives, using wireless communication, from the transmitting device 1 (i) the connect packet (9,600 bps) for establishing the communication connection and (ii) the data packet which contains the transfer data and whose communication speed is higher (for example, 4 Mbps) than that of the connect packet.

Then, the receiving device 2 includes (i) the connect packet judging section (first judging means) 31 which, when the reception status satisfies a predetermined first reception failure pattern, judges that the reception of the connect packet has failed, and (ii) the cause-of-error output section (notice information output means) 27 which, when the connect packet judging section 31 judges that the reception of the connect packet has failed, outputs to the user interface 3 the cause information capable of showing the cause of the reception failure so as to prompt the user to avoid the reception failure.

With this, when the reception failure of the connect packet has occurred, the user can instantly recognize the cause information (for example, information indicating that the distance between the receiving device and the transmitting device is short). As a result, the user can carry out the data transfer again using an appropriate method for avoiding the reception failure. That is, it is possible to avoid the frequent occurrence of the data transfer error.

As described above, there are the first reception failure patterns Co1 to Co3.

Moreover, the receiving device 2 includes the cause-of-error table storing section 26 which stores the first cause-of-error table (notice information table) in which there are plural kinds of first reception failure patterns, and which stores respective pieces of cause information determined in advance for respective first reception failure patterns.

Further, the receiving device 2 includes the cause-of-error judging section (notice information read-out means) 25 which, when the connect packet judging section 31 judges that the reception of the connect packet has failed, specifies the first reception failure pattern, and reads out from the first cause-of-error table the cause information corresponding to the specified first reception failure pattern. Then, the cause-of-error output section 27 outputs to the user interface 3 the cause information read out by the cause-of-error judging section 25.

According to the above-described configuration, the user can easily recognize the notice information corresponding to the first reception failure pattern. As a result, the user can carry out the data transfer again using an appropriate method for avoiding the reception failure in accordance with the reception status.

Moreover, the receiving device 2 includes the data packet judging section (second judging means) 32 which, depending on whether or not the reception status satisfies a predetermined second reception failure pattern, judges whether the reception of the data packet has succeeded or failed.

Then, when the connect packet judging section 31 judges that the reception of the connect packet has succeeded, and the data packet judging section 32 judges that the reception of the data packet has failed, the cause-of-error output section 27 outputs to the user interface 3 the cause information for showing the cause of the reception failure of the data packet so as to prompt the user to avoid the reception failure.

With this, when the connect packet has been successfully received but the reception failure of the data packet has occurred, the user can instantly recognize the cause information (for example, information indicating “Outside the communicable area of the communication speed corresponding to the data packet”) of the reception failure. As a result, the user can carry out the data transfer again using an appropriate method for avoiding the reception failure. That is, it is possible to avoid the frequent occurrence of the data transfer error.

As described above, there are the second reception failure patterns Da1 to Da8.

Moreover, the receiving device 2 stores the second cause-of-error table in which (i) there are a plurality of second reception failure patterns, and (ii) respective pieces of cause information are determined in advance for respective second reception failure patterns.

Then, when the data packet judging section 32 judges that the reception of the data packet has failed, the cause-of-error judging section 25 specifies the second reception failure pattern that the reception status satisfies, and reads out from the second cause-of-error table the cause information corresponding to the specified second reception failure pattern. Then, the cause-of-error output section 27 outputs to the user interface 3 the cause information read out by the cause-of-error judging section 25.

According to the above-described configuration, the user can easily recognize the notice information corresponding to the second reception failure pattern that the reception status satisfies. As a result, the user can carry out the data transfer again using an appropriate method for avoiding the reception failure in accordance with the reception status.

### Embodiment 2

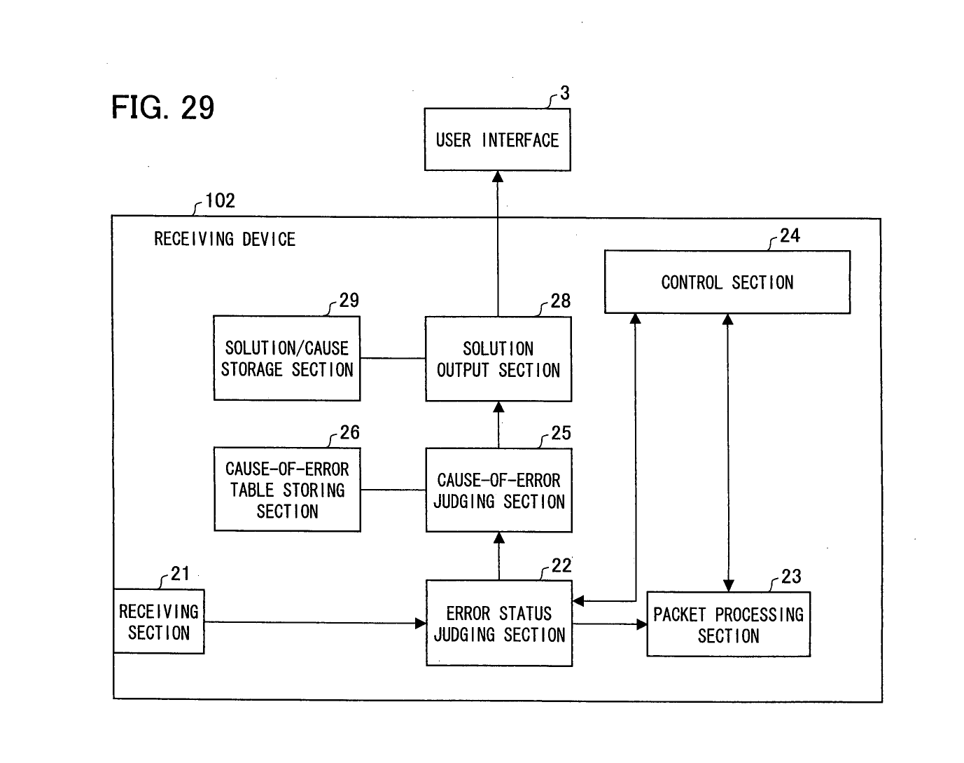

The following will explain another embodiment of the present invention in reference to FIGS. 29 to 31. For ease of explanation, the same reference numerals are used for the members having the same functions as the members shown in the figures explained in the above-described embodiment, and explanations thereof are omitted.

In the present embodiment, instead of the cause information of the reception error, the solution information indicating the solution to the reception error is output to the user interface. According to this, the user can easily recognize how to carry out the data transfer normally.

FIG. 29 is a diagram showing the configuration of an electronic apparatus of the present embodiment. As shown in FIG. 29, the electronic apparatus of the present embodiment includes a receiving device 102 and the user interface 3. Then, the receiving device 102 is similar to the receiving device 2 except that (i) the receiving device 102 includes a solution output section 28, instead of the cause-of-error output section 27 of the receiving device 2, and (ii) the receiving device 102 further includes a solution/cause storage section 29.

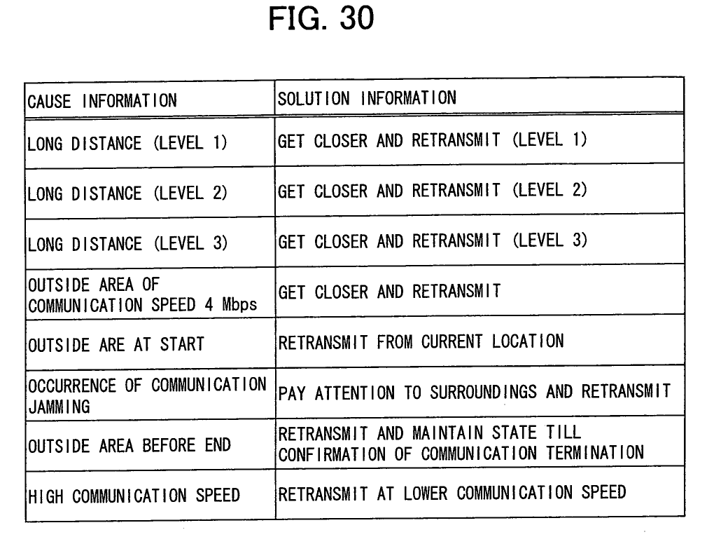

As shown in FIG. 30, the solution/cause storage section 29 stores a solution/cause table which associates (i) respective pieces of cause information stored in the cause-of-error table storing section with (ii) respective pieces of solution information indicating the solution to the cause indicated by the cause information.

The solution output section 28 reads out from the solution/cause storage section 29 the solution information corresponding to the cause information received from the cause-of-error judging section 25, and outputs the read-out solution information to the user interface 3.

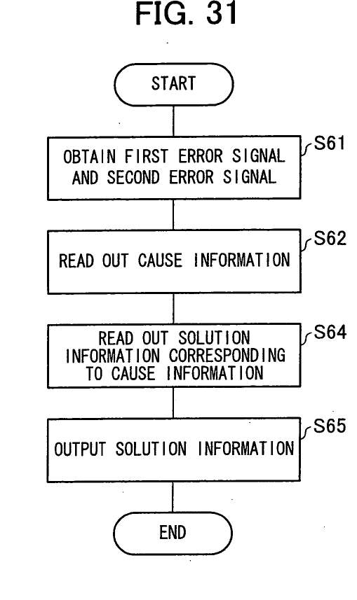

The reception processing of the connect packet and data packet in the receiving device 102 of the present embodiment is substantially the same as the flow of the flow chart of FIG. 17. However, the receiving device 102 of the present embodiment carries out a solution informing processing of FIG. 31, instead of S13 (that is, the cause-of-error informing processing of FIG. 22).

First, the cause-of-error judging section 25 receives the first error signal and the second error signal from the error status judging section 22 (S61). Next, the cause-of-error judging section 25 reads out from the cause-of-error table storing section 26 the cause information corresponding to the first error signal and the second error signal (S62). S61 and S62 are described above.

Then, the cause-of-error judging section 25 outputs the read-out cause information to the solution output section 28. Then, the solution output section 28 reads out from the solution/cause storage section 29 the solution information corresponding to the cause information received from the cause-of-error judging section 25 (S64).

Next, the solution output section 28 outputs the read-out solution information to the user interface 3, so as to inform the user of the solution (S65).

In the foregoing explanation, the solution/cause storage section 29 associates the cause information “Long distance” with the solution information “Get closer and retransmit”, and stores the cause information “Long distance” and the solution information “Get closer and retransmit”. However, as described in the modification example of Embodiment 1, there is the cause information “Outside the communicable angular range”.

In this case, the solution/cause storage section 29 may associate the cause information “Outside the communicable angular range” with the solution information “Confirm the angles of the transmitting device and the receiving device, and retransmit”, and stores the cause information “Outside the communicable angular range” and the solution information “Confirm the angles of the transmitting device and the receiving device, and retransmit”.

### Embodiment 3

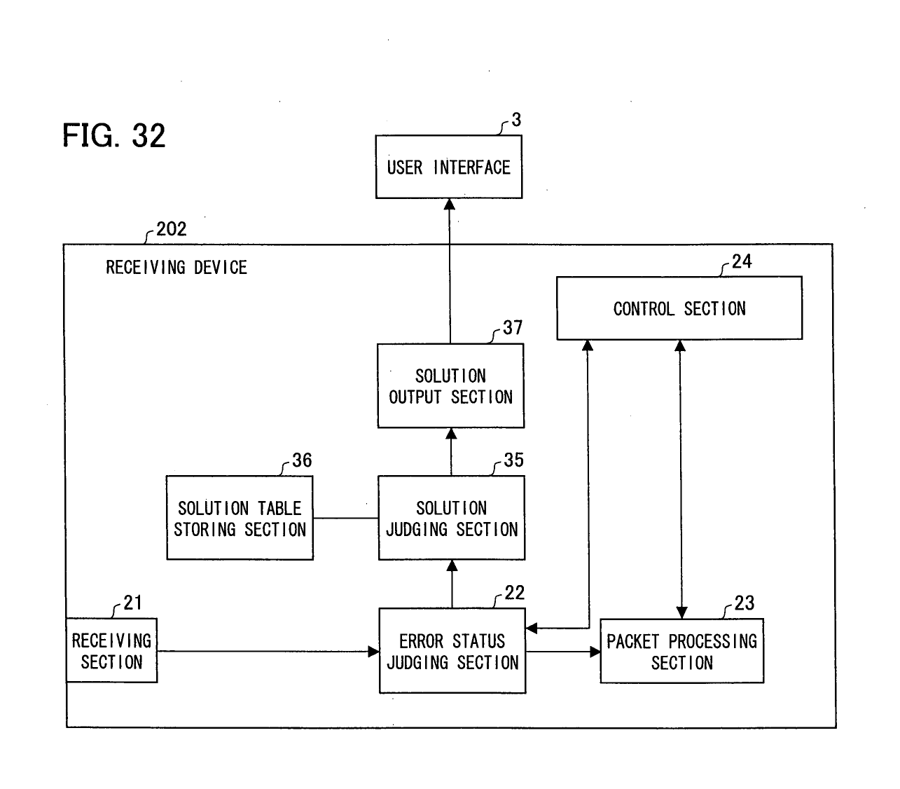

The following will explain yet another embodiment of the present invention in reference to FIGS. 32 to 35. For ease of explanation, the same reference numerals are used for the members having the same functions as the members shown in the figures explained in the above-described embodiments, and explanations thereof are omitted.

Similar to Embodiment 2, in the present embodiment, the solution information indicating the solution to the reception error is output to the user interface. According to this, the user can easily recognize how to carry out the data transfer normally.

FIG. 32 is a diagram showing the configuration of an electronic apparatus of the present embodiment. As shown in FIG. 32, the electronic apparatus of the present embodiment includes a receiving device 202 and the user interface 3. Then, the receiving device 202 is similar to the receiving device 2 except that the receiving device 202 includes (i) a solution judging section 35, instead of the cause-of-error judging section 25, (ii) a solution table storing section 36, instead of the cause-of-error table storing section 26, and (iii) a solution output section 37, instead of the cause-of-error output section 27.

The solution table storing section 36 stores (I) the first solution table which associates (i) the first error signals other than the first error signal <Co0> with (ii) respective pieces of solution information each indicating the solution to the error status indicated by the first error signal, and (II) the second solution table which, in the case of the first error signal <Co0>, associates (i) the second error signals with (ii) respective pieces of solution information each indicating the solution to the error status indicated by the second error signal.

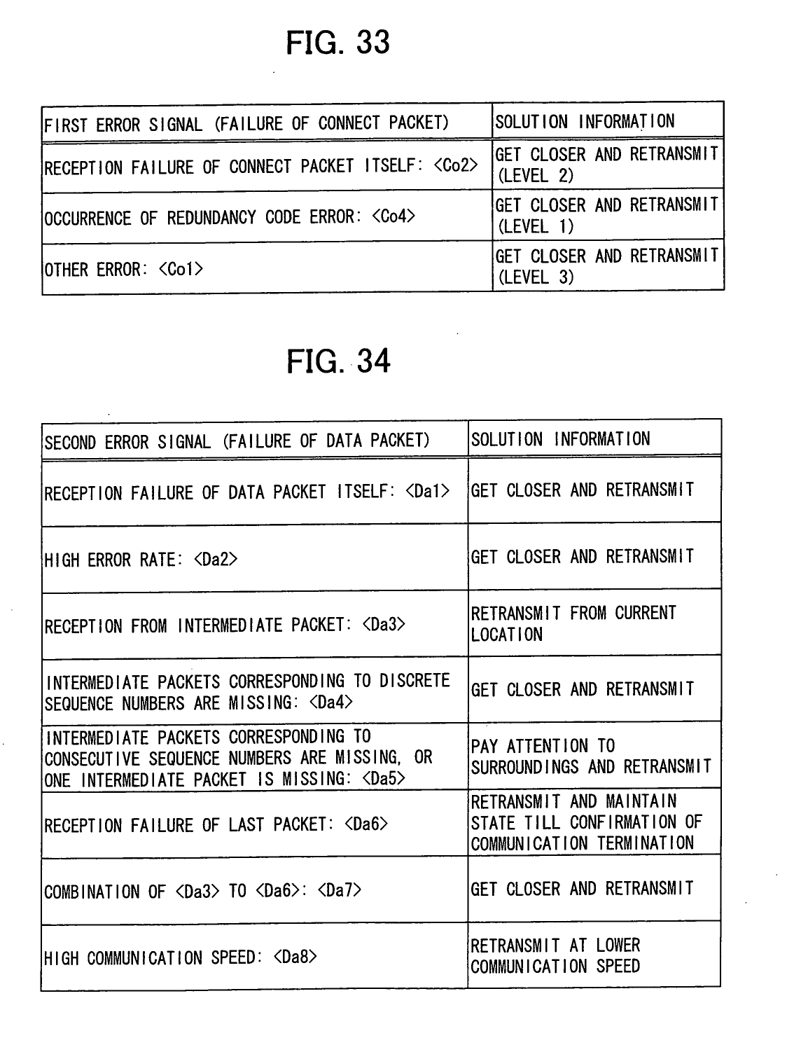

FIG. 33 is a diagram showing one example of the first solution table stored in the solution table storing section 36. Moreover, FIG. 34 is a diagram showing one example of the second solution table stored in the solution table storing section 36.

The solution judging section 35 reads out from the solution table storing section 36 the solution information corresponding to the first error signal and second error signal received from the error status judging section 22, and outputs the read-out solution information to the solution output section 37.

Specifically, when the solution judging section 35 has received the first error signal other than the first error signal <Co0>, it reads out from the first solution table, stored in the solution table storing section 36, the solution information corresponding to this first error signal. Moreover, when the solution judging section 35 has received the first error signal <Co0> and the second error signal other than the second error signal <Da0>, it reads out from the second solution table, stored in the solution table storing section 36, the solution information corresponding to this second error signal. Then, the solution judging section 35 outputs the read-out solution information to the solution output section 37.

The solution output section 37 outputs to the user interface 3 the solution information received from the solution judging section 35, so as to inform the user of the solution.

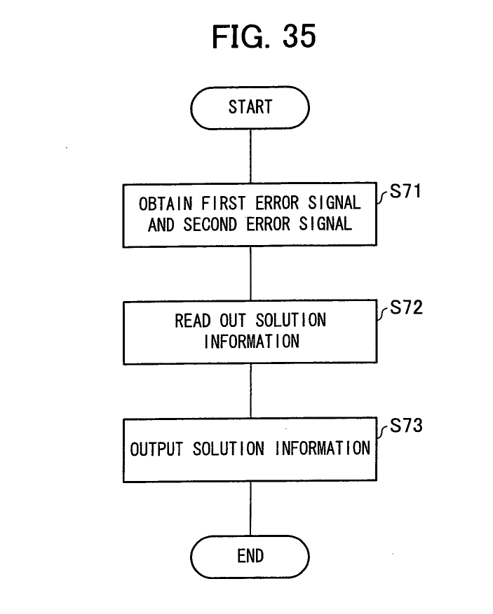

The reception processing of the connect packet and data packet in the receiving device 202 of the present embodiment is substantially the same as the flow of the flow chart of FIG. 17. However, the receiving device 202 of the present embodiment carries out the solution informing processing of FIG. 35, instead of S13 (that is, the cause-of-error informing processing of FIG. 22).

First, the solution judging section 35 receives the first error signal and the second error signal from the error status judging section 22 (S71). Next, the solution judging section 35 reads out from the solution table storing section 36 the solution information corresponding to the first error signal and the second error signal (S72).

Then, the solution judging section 35 outputs the read-out solution information to the solution output section 37. Then, the solution output section 37 outputs to the user interface 3 the solution information received from the solution judging section 35, so as to inform the user of the solution (S73).

For example, when the solution judging section 35 has received the first error signal <Co1>, it reads out the solution information “Get closer and retransmit (Level 3)” from the first solution table of FIG. 33. Then, the solution output section 37 causes the user interface 3 to display this solution information. With this, when the reception status is such that the receiving device 202 has received three or more pulse trains corresponding to the communication speed of the connect packet, but the higher layer(s) has not recognized the connect packet normally, the user can recognize that the distance between the receiving device 2 and the transmitting device 1 needs to be shortened further.

Moreover, when the solution judging section 35 has received the first error signal <Co2>, it reads out the solution information “Get closer and retransmit (Level 2)” from the first solution table of FIG. 33. Then, the solution output section 37 causes the user interface 3 to display this solution information. With this, when the reception status is such that the receiving device 202 has received three or more pulse trains corresponding to Additional BOF, but has not received the connect packet, the user can recognize that the distance between the receiving device 2 and the transmitting device 1 needs to be shortened further.

Moreover, when the solution judging section 35 has received the first error signal <Co3>, it reads out the solution information “Get closer and retransmit (Level 1)” from the first solution table of FIG. 33. Then, the solution output section 37 causes the user interface 3 to display this solution information. With this, when the reception status is such that the error of the connect packet has been detected by the redundancy code, the user can recognize that the distance between the receiving device 2 and the transmitting device 1 needs to be shortened further.

Moreover, when the solution judging section 35 has received the first error signal <Co0> and the second error signal <Da1> (or <Da2>, <Da4>, or <Da7>), it reads out the solution information “Get closer and retransmit” from the second solution table of FIG. 34. Then, the solution output section 37 causes the user interface 3 to display this solution information. With this, the user can recognize that the distance between the receiving device 2 and the transmitting device 1 needs to be shortened. As a result, it is possible to carry out the data transfer normally.

Moreover, when the solution judging section 35 has received the first error signal <Co0> and the second error signal <Da3>, it reads out the solution information “Retransmit from the current location” from the second solution table of FIG. 34. Then, the solution output section 37 causes the user interface 3 to display this solution information. With this, the user can recognize that the data transfer can be carried out normally by carrying out retransmission from a current location.

Moreover, when the solution judging section 35 has received the first error signal <Co0> and the second error signal <Da5>, it reads out the solution information “Pay attention to surroundings and retransmit” from the second solution table of FIG. 34. Then, the solution output section 37 causes the user interface 3 to display this solution information. With this, by carrying out retransmission after confirming the existence of the communication jamming, the user can carry out the data transfer normally.

Moreover, when the solution judging section 35 has received the first error signal <Co0> and the second error signal <Da6>, it reads out the solution information “Retransmit and maintain the state till the confirmation of the communication termination” from the second solution table of FIG. 34. Then, the solution output section 37 causes the user interface 3 to display this solution information. With this, by carrying out retransmission without changing the location of the transmitting device 1 till the reception completion, the user can carry out the data transfer normally.

Moreover, when the solution judging section 35 has received the first error signal <Co0> and the second error signal <Da8>, it reads out the solution information “Retransmit at the lower communication speed” from the second solution table of FIG. 34. Then, the solution output section 37 causes the user interface 3 to display this solution information. With this, by carrying out retransmission at a lower communication speed, the user can carry out the data transfer normally.

Note that FIG. 33 shows just one example of the first solution table, and FIG. 34 shows just one example of the second solution table. The solution table storing section 36 may store the solution information different from the solution information shown in FIGS. 33 and 34.

For example, the solution table storing section 36 may associate each of the first error signals <Co1> to <Co3> with the solution information “Confirm the angles of the transmitting device and the receiving device, and retransmit”, and store the first error signals <Co1> to <Co3> and the solution information “Confirm the angles of the transmitting device and the receiving device, and retransmit”.

Similarly, the solution table storing section 36 may associate each of the second error signal <Da1>, <Da2>, <Da4>, and <Da7> with the solution information “Confirm the angles of the transmitting device and the receiving device, and retransmit”, and store the second error signals <Da1>, <Da2>, <Da4>, and <Da7> and the solution information “Confirm the angles of the transmitting device and the receiving device, and retransmit”.

The present invention is not limited to the description of the embodiments above, but may be altered by a skilled person within the scope of the claims. An embodiment based on a proper combination of technical means disclosed in different embodiments is encompassed in the technical scope of the present invention.

Lastly, each of respective blocks of the receiving device 2, the error status judging section 22, the control section 24, the cause-of-error judging section 25, the cause-of-error output section 27, the solution output sections 28 and 37, and the solution judging section 35 may be configured by a hardware logic, or may be realized by software using a CPU in the following manner.

That is, the receiving device 2 includes: a CPU (central processing unit) which executes a command of a control program for realizing each function; a ROM (read only memory) which stores the control program; a RAM (random access memory) which loads the control program; a storage device (recording medium), such as a memory, which stores the control program and various data; and the like. Then, an object of the present invention can be achieved by supplying a computer-readable recording medium to the receiving device 2 and then causing its computer (CPU, MPU, or the like) to read out and execute a program code (executable format program, intermediate code program, source program) of the control program of the receiving device 2, the control program being software that realizes the above-described functions.

Examples of the recording medium are (i) a tape, such as a magnetic tape or a cassette tape, (ii) a disc, such as a magnetic disc (a floppy® disc, a hard disc, etc.) or an optical disc (a CD-ROM, an MO, an MD, a DVD, a CD-R, etc.), (iii) a card, such as an IC card (including a memory card) or an optical card, (iv) a semiconductor memory, such as a mask ROM, an EPROM, an EEPROM, a flash ROM, etc.

Moreover, the receiving device 2 may be configured so as to be connectable with a communication network, so that the program code may be supplied through the communication network. The communication network is not especially limited, and may be, for example, the Internet, an intranet, an extranet, a LAN, an ISDN, a VAN, a CATV communication network, a virtual private network, a telephone network, a mobile communication network, a satellite communication network, or the like. Moreover, a transmission medium constituting the communication network is not especially limited, and may be, for example, (i) a fixed line, such as an IEEE1394, a USB, a power line carrier, a cable TV circuit, a telephone line, or an ADSL, or (ii) a wireless, such as an infrared (an IrDA, a remote control), a Bluetooth®, an 802.11 wireless, an HDR, a mobile phone network, a satellite circuit, or a ground wave digital network. Note that the present invention can be realized even in the case where the program code is in the form of a computer data signal which is realized by an electronic transmission and is embedded in a carrier wave.

As described above, a communication system according to the embodiments of the present invention carries out wireless communication between the transmitting device and the receiving device, using a plurality of different communication speeds, and the lower communication speed is used for establishing the connection, and the higher communication speed than the communication speed for establishing the connection is used for the data transfer.

Moreover, there are the connect packet for establishing the connection and the data packet for the data transfer, each of which is a packet that is a group of data created by adding to a transmission data a communication signal and/or the redundancy code for the error detection.

Then, the receiving device includes the error status judging section 22 (I) which has a function of being able to, when the receiving device has not received the connect packet normally, detect that (i) the receiving device has not received the connect packet normally and (ii) how the reception status was when the receiving device has not received the connect packet normally, and (II) which has a function of being able to, when the receiving device has not received the data packet normally, detect that (i) the receiving device has not received the data packet normally and (ii) how the reception status was when the receiving device has not received the data packet normally.

Further, the receiving device includes the cause-of-error judging section 25 which judges the cause of the communication failure on the basis of the judgment of the error status judging section 22.

Moreover, the receiving device includes the cause-of-error output section 27 which informs the user of the cause, judged by the cause-of-error judging section 25, of the communication failure.

Alternatively, the receiving device includes the solution output section 28 which solves the cause, judged by the cause-of-error judging section 25, of the communication failure, and informs the user of the solution for successfully carrying out communication.

Here, when the error status judging section 22 has received a pattern indicating the beginning of a packet and a pattern indicating the ending of the packet, but an error has been detected by the redundancy code for detecting the error, the error status judging section 22 judges that the connect packet has not been received normally.

Alternatively, when the error status judging section 22 has received at least three pulses of a desired frequency band, but has not received the connect packet, it judges that the connect packet has not been received normally.

Alternatively, when the error status judging section 22 has received at least three specific pulse trains transmitted, before transmitting a packet, for stabilizing a reception amp, but has not received the connect packet, it judges that the connect packet has not been received normally.

Alternatively, when the error status judging section 22 has received data necessary for establishing the connection, but has not received the connect packet, it judges that the connect packet has not been received normally.

Moreover, when the cause-of-error judging section 25 does not receive the connect packet normally, it judges that the transmitting device has been outside the communicable range. Then, based on the judgment of the cause-of-error judging section 25, the solution output section 28 informs the user of a message indicating that the transmitting device should get close to the receiving device and then carry out retransmission.

Alternatively, when the cause-of-error judging section 25 does not receive the connect packet normally, it judges that the transmitting device has been outside the communicable angular range. Then, based on the judgment of the cause-of-error judging section 25, the solution output section 28 informs the user of a message indicating that the directions of the transmitting section and receiving section should be corrected, and then retransmission should be carried out.

Moreover, when the error status judging section 22 detects a pulse of a desired frequency band, but does not receive a packet which can be recognized as the data packet, it judges that the data packet has not been received normally.

Alternatively, when the error rate detected by the redundancy code is higher than a predetermined error rate (for example, 10⁻⁸), the error status judging section 22 judges that the connect packet has not been received normally.

Alternatively, when the error status judging section 22 has received a packet corresponding to the sequence number indicating the beginning and a packet corresponding to the sequence number indicating the ending, but has not received a packet(s) corresponding to the intermediate sequence number(s), it judges that the connect packet has not been received normally.

Alternatively, in the case where (i) packets are continuously transmitted, (ii) a transmission method is such that the order of packets are managed by the sequence numbers held in fields indicating that the packets are lined up in order, and (iii) the error status judging section 22 does not receive the packets sequentially from the packet corresponding to the sequence number indicating the beginning, but receives the packets from the packet corresponding to the intermediate sequence number, the error status judging section 22 judges that the connect packet has not been received normally.

In this case, the cause-of-error judging section 25 judges that the transmitting device has been outside the communicable range at the start of the communication but has gotten inside the communicable range at the middle of the communication. Then, based on the judgment of the cause-of-error judging section 25, the solution output section 28 informs the user of a message indicating that retransmission should be carried out from a current location.

Alternatively, the cause-of-error judging section 25 judges that the transmitting section has been outside the communicable range at the start of the communication, but has gotten inside the communicable range at the middle of the communication. Then, based on the judgment of the cause-of-error judging section 25, the solution output section 28 informs the user of a message indicating that the directions of the transmitting section and the receiving section should be corrected, and then retransmission should be carried out.

Alternatively, when the error status judging section 22 has received a packet corresponding to the sequence number indicating the beginning and a packet corresponding to the sequence number indicating the ending, but has not received a group of packets corresponding to the successive sequence numbers, it judges that the connect packet has not been received normally.

In this case, the cause-of-error judging section 25 judges that a phenomenon which interferes the communication has occurred temporarily during the communication. Then, based on the judgment of the cause-of-error judging section 25, the solution output section 28 informs the user of a message indicating that retransmission should be carried out while paying attention to the surroundings.

Alternatively, when the error status judging section 22 has not received the packet corresponding to the sequence number indicating the ending, it judges that the connect packet has not been received normally.

In this case, the cause-of-error judging section 25 judges that the transmitting device has gone outside the communicable range before the communication termination or the transmitting device has changed its direction so as to be outside the communicable range before the communication termination. Then, based on the judgment of the cause-of-error judging section 25, the solution output section 28 informs the user of a message indicating that the transmitting device should get close to the receiving device, carry out retransmission, and maintain the state until the confirmation of the communication termination or a message indicating that the directions of the transmitting section and the receiving section should be corrected, and the transmitting device should carry out retransmission and maintain the state until the confirmation of the communication termination.

Moreover, when the cause-of-error judging section 25 has received a packet for establishing a connection but has not received the data packet normally, it judges that the transmitting device has been outside the communicable range necessary for carrying out the data transfer whose speed is higher than that of the packet for establishing the connection. Then, based on the judgment of the cause-of-error judging section 25, the solution output section 28 informs the user of a message indicating that the transmitting device should get close to the receiving device, and carry out retransmission.

Moreover, when the cause-of-error judging section 25 does not receive the data packet normally due to a combination of a plurality of above-described error statuses, it judges that the transmitting device has been outside the communicable range necessary for carrying out the data transfer whose speed is higher than that of the packet for establishing the connection. Then, based on the judgment of the cause-of-error judging section 25, the solution output section 28 informs the user of a message indicating that the transmitting device should get closer to the receiving device, and carry out retransmission.

Moreover, when the cause-of-error judging section 25 does not receive the data packet normally, it may judge that the transmitting device has been outside the communicable angular range at the start of the communication, but has gotten inside the communicable angular range at the middle of the communication. Then, based on the judgment of the cause-of-error judging section 25, the solution output section 28 informs the user of a message indicating that the directions of the transmitting section and the receiving section should be corrected and then retransmission should be carried out.

Moreover, when it is well-known that the data transfer speed of the transmitting device is changeable, the solution output section 28 may inform, based on the judgment of the cause-of-error judging section 25, the user of a message indicating that retransmission should be carried out at a lower data transmission speed.

Moreover, the electronic apparatus of the present invention may be an image forming apparatus having the receiving device, a recording apparatus having the receiving device, or a printing apparatus having the receiving device.

Then, each device has informing means for informing the user of the judgment of the cause-of-error judging section 25. Alternatively, each device has informing means for informing the user of a message from the solution output section 28 or 37.

In the case where the electronic apparatus is the image displaying apparatus, the image displaying apparatus displays the judgment of the cause-of-error judging section 25, so as to inform the user of it. Alternatively, the image displaying apparatus displays the message from the solution output section 28 or 37, so as to inform the user of it.

Note that in the communication system, the infrared is used as a communication medium. For example, used are (i) IrDA (Infrared Data Association) and (ii) a communication system (IrSimple (Infrared Simple)) in which all pieces of data for establishing the connections of respective communication layers are transmitted together.

Moreover, 9,600 bps is used as the communication speed for establishing the connection. Further, 4 Mbps is used as the communication speed for the data transfer.

Moreover, the electronic apparatus includes informing means for informing the user of the location of the infrared receiving section. In the case where the electronic apparatus is the image displaying apparatus, the image displaying apparatus carries out a display, on this display screen, for informing the user of the location of the infrared receiving section.

As described above, according to a receiving device, communication system, receiving method, receiving device control program of the present invention, the user can carry out a solution appropriately, and can carry out the data transfer surely. Therefore, for example, the present invention can preferably be used for the communication from a mobile device to another mobile device, from the mobile device to a printer, from the mobile device to a display device, from the mobile device to an audio-video equipment (recording apparatus) such as a DVD recorder, etc.

As described above, a receiving device of the present invention receives, using wireless communication, from a transmitting device (i) a connect packet for establishing a communication connection and (ii) a data packet which contains transfer data and whose communication speed is higher than that of the connect packet, and the receiving device includes: first judging means for judging, when a reception status satisfies a predetermined first reception failure pattern, that a reception of the connect packet has failed; and notice information output means for, when said first judging means judges that a reception failure has occurred, outputting notice information, for prompting a user to avoid the reception failure, to a user interface.

Moreover, a communication method of the present invention is used in a receiving device which receives, using wireless communication, from a transmitting device (i) a connect packet for establishing a communication connection and (ii) a data packet which contains transfer data and whose communication speed is higher than that of the connect packet, and the communication method includes the steps of: (i) judging by first judging means of the receiving device, when a reception status satisfies a predetermined first reception failure pattern, that a reception of the connect packet has failed; and (ii) when said first judging means judges that the reception failure has occurred, outputting notice information, for prompting a user to avoid the reception failure, to a user interface by notice information output means of the receiving device.

According to the above-described configuration, when the reception status satisfies the predetermined first reception failure pattern, the first judging means judges that the reception of the connect packet has failed. Then, when the first judging means judges that the reception failure has occurred, the notice information output means outputs to the user interface the notice information for prompting the user to avoid the reception failure.

Therefore, when the reception failure has occurred, the user can instantly recognize the notice information (for example, information indicating that the distance between the receiving device and the transmitting device is short) for prompting the user to avoid the reception failure. As a result, the user can carry out the data transfer again using an appropriate method for avoiding the reception failure. That is, it is possible to avoid the frequent occurrence of the data transfer error.

Further, in addition to the above-described configuration, the receiving device of the present invention further includes first pulse detecting means for detecting a first pulse corresponding to the communication speed of the connect packet, and when the first pulse detecting means has detected a predetermined number of the first pulses, but has not received the connect packet within a predetermined time, the first judging means judges that the reception of the connect packet has failed.

According to the above-described configuration, when the first pulse corresponding to the communication speed of the connect packet has been detected, but the connect packet transmitted at the first pulse has not been received, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, in the receiving device of the present invention, an error-detecting code is added to the connect packet, and when an error has been detected in the connect packet, received successfully, by using the error-detecting code, the first judging means judges that the reception of the connect packet has failed.

According to the above-described configuration, when the connect packet has been received, but the error has been detected in the connect packet, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, the receiving device of the present invention further includes specific pulse train detecting means for detecting a specific pulse train transmitted before the connect packet, and when the specific pulse train detecting means has detected a predetermined number of the specific pulse trains, but the reception of the connect packet has not been confirmed within a predetermined time, the first judging means judges that the reception of the connect packet has failed.

Note that the specific pulse train is, for example, the Additional BOF and is transmitted for stabilizing a reception amp.

According to the above-described configuration, when part of the specific pulse train transmitted before the connect packet has been received, but the connect packet has not been received, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, in the receiving device of the present invention, the connect packet includes (i) a data portion containing data necessary for establishing the communication connection, and (ii) an additional portion, and when the reception of the data portion has been detected, but the reception of the additional portion has failed, the first judging means judges that the reception of the connect packet has failed.

According to the above-described configuration, when a parameter(s), contained in the connect packet, necessary for establishing a connection has been received, but the connect packet has not entirely been received, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, the receiving device of the present invention further includes: plural kinds of the first reception failure patterns; a notice information table which stores the notice information determined in advance for each of the first reception failure patterns; and notice information read-out means for, when the first judging means judges that the reception of the connect packet has failed, (i) specifying the first reception failure pattern that the reception status satisfies and (ii) reading out from the notice information table the notice information corresponding to the specified first reception failure pattern, and the notice information output means outputs to the user interface the notice information read out by the notice information read-out means.

According to the above-described configuration, the user can easily recognize the notice information corresponding to the first reception failure pattern that the reception status satisfies. As a result, the user can carry out the data transfer again using an appropriate method for avoiding the reception failure in accordance with the reception status.

Moreover, a receiving device of the present invention receives, using wireless communication, from a transmitting device (i) a connect packet for establishing a communication connection and (ii) a data packet which contains transfer data and whose communication speed is higher than that of the connect packet, and the receiving device includes: first judging means for judging, depending on whether or not a reception status satisfies a predetermined first reception failure pattern, whether a reception of the connect packet has succeeded or failed; second judging means for judging, depending on whether or not the reception status satisfies a predetermined second reception failure pattern, whether a reception of the data packet has succeeded or failed; and notice information output means for, when said first judging means judges that the reception of the connect packet has succeeded and said second judging means judges that the reception of the data packet has failed, outputting notice information, for prompting a user to avoid the reception failure of the data packet, to a user interface.

Moreover, a communication method of the present invention is used in a receiving device which receives, using wireless communication, from a transmitting device (i) a connect packet for establishing a communication connection and (ii) a data packet which contains transfer data and whose communication speed is higher than that of the connect packet, and the communication method includes the steps of: (i) judging by first judging means of the receiving device, depending on whether or not a reception status satisfies a predetermined first reception failure pattern, whether a reception of the connect packet has succeeded or failed; (ii) judging by second judging means of the receiving device, depending on whether or not the reception status satisfies a predetermined second reception failure pattern, whether a reception of the data packet has succeeded or failed; and (iii) when said first judging means judges that the reception of the connect packet has succeeded and said second judging means judges that the reception of the data packet has failed, outputting notice information, for prompting a user to avoid the reception failure of the data packet, to a user interface by notice information output means of the receiving device.

According to the above-described configuration, when the first judging means judges that the reception of the connect packet has succeeded, and the second judging means judges that the reception of the data packet has failed, the notice information output means outputs to the user interface the notice information for prompting the user to avoid the reception failure of the data packet.

Therefore, when the reception of the connect packet has succeeded, but the reception of the data packet has failed, the user can instantly recognize the notice information (for example, information indicating “Outside the communicable area of the communication speed corresponding to the data packet) for prompting the user to avoid the reception failure. As a result, the user can carry out the data transfer again using an appropriate method for avoiding the reception failure. That is, it is possible to avoid the frequent occurrence of the data transfer error.

Further, in addition to the above-described configuration, the receiving device of the present invention further includes second pulse detecting means for detecting a second pulse corresponding to the communication speed of the data packet, and when the second pulse detecting means has detected a predetermined number of the second pulses, but the reception of the data packet has not been confirmed, the second judging means judges that the reception of the data packet has failed.

According to the above-described configuration, when the second pulse corresponding to the communication speed of the data packet has been detected, but the data packet transmitted at the second pulse has not been received, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, the receiving device of the present invention further includes communication speed detecting means for detecting the communication speed of the data packet, and when the communication speed detecting means detects the data packet whose communication speed is higher than that of the connect packet received successfully, the second judging means judges that the reception of the data packet has failed.

According to the above-described configuration, when the data packet whose communication speed is higher than that of the connect packet has been received, the receiving device judges that the reception failure has occurred. Then, when the receiving device judges that the reception failure has occurred, the user can confirm the notice information (for example, information indicating that the communication speed is high) corresponding to the reception failure. As a result, the user can carry out the data transfer again using an appropriate method for avoiding the reception failure.

Further, in addition to the above-described configuration, in the receiving device of the present invention, an error-detecting code is added to the data packet, and when the error rate, detected by using the error-detecting code, of received data is a predetermined threshold value or higher, the second judging means judges that the reception of the data packet has failed.

According to the above-described configuration, when the data packet has been received, but the error rate of the data is a predetermined threshold value or higher, the receiving device judges that the reception failure has occurred. Then, when the receiving device judges that the reception failure has occurred, the user can confirm the notice information corresponding to the reception failure. As a result, the user can carry out the data transfer again using an appropriate method for avoiding the reception failure.

Further, in addition to the above-described configuration, in the receiving device of the present invention, the wireless communication is infrared communication, and the threshold value is 1×10⁻⁸.

According to the above-described configuration, in the infrared communication of IrDA, the receiving device can judge that the reception failure has occurred due to the bad communication condition.

Further, in addition to the above-described configuration, in the receiving device of the present invention, (i) there are a plurality of the data packets, (ii) sequence numbers, indicating orders, are given to the data packets, respectively, and (iii) when the data packet corresponding to the sequence number indicating a beginning has not been received, the second judging means judges that the reception of the data packets has failed.

According to the above-described configuration, when the data packet corresponding to the sequence number indicating the beginning has not been received, but the data packets have been received from the data packet corresponding to the intermediate sequence number, the receiving device judges that the reception failure has occurred. Then, when the receiving device judges that the reception failure has occurred, the user can confirm the notice information (for example, information indicating “Outside the communicable area at the start) corresponding to the reception failure. As a result, the user can carry out the data transfer again using an appropriate method for avoiding the reception failure.

Further, in addition to the above-described configuration, in the receiving device of the present invention, (i) there are a plurality of the data packets, (ii) sequence numbers, indicating orders, are given to the data packets, respectively, and (iii) when the data packet corresponding to the sequence number indicating an ending has not been received, or when the data packet, whose one field indicating whether or not the data packet is a last one indicates that the data packet is the last one, has not been received, the second judging means judges that the reception of the data packets has failed.

According to the above-described configuration, when the data packet corresponding to the sequence number indicating the ending has not been received, or when the data packet, whose one field indicating whether or not the data packet is the last one indicates that the data packet is the last one, has not been received, the receiving device judges that the reception failure has occurred. Then, when the receiving device judges that the reception failure has occurred, the user can confirm the notice information (for example, information indicating “Outside the communicable area before the end of transmission”) corresponding to the reception failure. As a result, the user can carry out the data transfer again using an appropriate method for avoiding the reception failure.

Further, in addition to the above-described configuration, in the receiving device of the present invention, (i) there are a plurality of the data packets, (ii) sequence numbers, indicating orders, are given to the data packets, respectively, and (iii) when the data packet corresponding to the sequence number indicating a beginning and the data packet corresponding to the sequence number indicating an ending have been received, but the data packet corresponding to an intermediate sequence number has not been received, the second judging means judges that the reception of the data packets has failed.

According to the above-described configuration, when the data packet corresponding to the sequence number indicating the beginning and the data packet corresponding to the sequence number indicating the ending have been received, but the data packet(s) corresponding to the intermediate sequence number(s) has not been received, the receiving device judges that the reception failure has occurred. Then, when the receiving device judges that the reception failure has occurred, the user can confirm the notice information (for example, information indicating that the distance between the receiving device and the transmitting device is long) corresponding to the reception failure. As a result, the user can carry out the data transfer again using an appropriate method for avoiding the reception failure.

Further, in addition to the above-described configuration, in the receiving device of the present invention, (i) there are a plurality of the data packets, (ii) sequence numbers, indicating orders, are given to the data packets, respectively, and (iii) when the data packet corresponding to the sequence number indicating a beginning and the data packet corresponding to the sequence number indicating an ending have been received, but only the data packets corresponding to consecutive intermediate sequence numbers have not been received, the second judging means judges that the reception of the data packets has failed.

According to the above-described configuration, when the data packet corresponding to the sequence number indicating the beginning and the data packet corresponding to the sequence number indicating the ending have been received, but only the data packets corresponding to the consecutive intermediate sequence numbers have not been received, the receiving device judges that the reception failure has occurred. Then, when the receiving device judges that the reception failure has occurred, the user can confirm the notice information (for example, information indicating that the communication jamming has occurred in the middle of the data transfer) corresponding to the reception failure. As a result, the user can carry out the data transfer again using an appropriate method for avoiding the reception failure.

Further, in addition to the above-described configuration, in the receiving device of the present invention, (i) there are a plurality of the data packets, (ii) sequence numbers, indicating orders, are given to the data packets, respectively, and (iii) when the data packet corresponding to at least one of the sequence numbers has not been received, the second judging means judges that the reception of the data packets has failed.

According to the above-described configuration, when the data packets corresponding to all the sequence numbers have not been received completely, the receiving device judges that the reception failure has occurred. Then, when the receiving device judges that the reception failure has occurred, the user can confirm the notice information (for example, information indicating that the distance between the receiving device and the transmitting device is long) corresponding to the reception failure. As a result, the user can carry out the data transfer again using an appropriate method for avoiding the reception failure.

Further, in addition to the above-described configuration, the receiving device of the present invention further includes: plural kinds of the second reception failure patterns; a notice information table which stores the notice information determined in advance for each of the second reception failure patterns; and notice information read-out means for, when the second judging means judges that the reception of the data packet has failed, (i) specifying the second reception failure pattern that the reception status satisfies and (ii) reading out from the notice information table the notice information corresponding to the specified second reception failure pattern, and the notice information output means outputs to the user interface the notice information read out by said notice information read-out means.

According to the above-described configuration, the user can easily confirm the notice information corresponding to the second reception failure pattern that the reception status satisfies. As a result, the user can carry out the data transfer again using an appropriate method for avoiding the reception failure in accordance with the reception status.

Further, in addition to the above-described configuration, in the receiving device of the present invention, the notice information is cause information indicating a cause of the reception failure.

According to the above-described configuration, the user can recognize the cause of the reception failure. As a result, the user can eliminate the cause, and then carry out the data transfer again. In this way, the user can avoid the reception failure.

Further, in addition to the above-described configuration, in the receiving device of the present invention, the notice information is solution information indicating a solution to the reception failure.

According to the above-described configuration, the user can recognize the solution to the reception failure. As a result, the user can carry out the data transfer again in accordance with the solution. In this way, the user can avoid the reception failure.

Further, in addition to the above-described configuration, in the receiving device of the present invention, the wireless communication is infrared communication.

According to the above-described configuration, one example of the data transfer using infrared is the IrDA standard, as described above. Therefore, for example, regarding the receiving device adopting a transfer method compliant with the IrDA standard, it is possible to reduce the probability of causing the communication failure because of the angle between the devices being a certain angle or larger, or the distance between the devices being a certain distance or longer.

Further, in addition to the above-described configuration, in the receiving device of the present invention, (i) the communication speed of the connect packet is 9,600 bps, and (ii) the communication speed of the data packet is 4 Mbps.

The above-described configuration adopts a widely-used communication speed among the wireless communications defined in the IrDA standard. Therefore, in many of communication systems adopting the IrDA standard, the user can avoid the reception failure, and then carry out the data transfer again. In this way, the user can reduce the probability of causing the communication failure.

Moreover, an electronic apparatus of the present invention includes (i) the above-described receiving device and (ii) a user interface to which the notice information output means of the receiving device outputs the notice information.

According to the above-described configuration, the user can confirm the notice information by the user interface. As a result, the user can carry out the data transfer again using an appropriate method for avoiding the reception failure. That is, it is possible to avoid the frequent occurrence of the data transfer error.

Further, in addition to the above-described configuration, the electronic apparatus of the present invention is an image displaying apparatus which displays data received from the transmitting device.

According to this, the user can confirm data, transferred to the image displaying apparatus, on a display screen. Then, when the reception failure has occurred, the user can confirm the notice information so as not to repeatedly carry out the data transfer with respect to the image displaying apparatus.

Further, in addition to the above-described configuration, in the electronic apparatus of the present invention, the user interface is a display section.

With this, the user can easily confirm the notice information visually.

Further, in addition to the above-described configuration, the electronic apparatus of the present invention is a recording apparatus which records data received from the transmitting device.

According to this, the user can cause a recording medium to record the data transferred to the recording apparatus. Then, when the reception failure has occurred, the user can confirm the notice information so as not to repeatedly carry out the data transfer with respect to the recording apparatus.

Further, in addition to the above-described configuration, the electronic apparatus of the present invention is a printing apparatus which prints out data received from the transmitting device.

According to this, the user can cause the printing apparatus to print out the data transferred to the printing apparatus. Then, when the reception failure has occurred, the user can confirm the notice information so as not to repeatedly carry out the data transfer with respect to the printing apparatus.

Further, in addition to the above-described configuration, the wireless communication is infrared communication in the electronic apparatus of the present invention, and the electronic apparatus further includes: an infrared receiving section which receives infrared; and light receiving location informing means for informing a user of a location of the infrared receiving section.

According to the above-described configuration, the user can easily recognize the location of the infrared receiving section.

Further, in addition to the above-described configuration, the electronic apparatus of the present invention is an image displaying apparatus which displays data received from the transmitting device, and the light receiving location informing means causes a display screen to display the location of the infrared receiving section.

According to the above-described configuration, the user can easily recognize the location of the infrared receiving section visually.

Therefore, the user can carry out the data transfer again using an appropriate method for avoiding the reception failure. That is, it is possible to avoid the frequent occurrence of the data transfer error.

Note that the receiving device may be realized by a computer. In this case, the present invention includes a communication program causing a computer to function as the above-described respective means so as to realize the receiving device by the computer, and a computer-readable recording medium recording this communication program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A receiving device which receives, using wireless communication, from a transmitting device (i) a connect packet for establishing a communication connection and (ii) a data packet which contains transfer data and whose communication speed is higher than that of the connect packet, the receiving device comprising:
first judging means for judging, when a reception status satisfies a predetermined first reception failure pattern, that a reception of the connect packet has failed; and
notice information output means for, when said first judging means judges that a reception failure has occurred, outputting notice information, for prompting a user to avoid the reception failure, to a user interface.

2. The receiving device as set forth in claim 1, further comprising
first pulse detecting means for detecting a first pulse corresponding to the communication speed of the connect packet,
wherein, when said first pulse detecting means has detected a predetermined number of the first pulses, but has not received the connect packet within a predetermined time, said first judging means judges that the reception of the connect packet has failed.

3. The receiving device as set forth in claim 1, wherein:
an error-detecting code is added to the connect packet; and
when an error has been detected in the connect packet, received successfully, by using the error-detecting code, said first judging means judges that the reception of the connect packet has failed.

4. The receiving device as set forth in claim 1, further comprising
specific pulse train detecting means for detecting a specific pulse train transmitted before the connect packet,
wherein, when said specific pulse train detecting means has detected a predetermined number of the specific pulse trains, but the reception of the connect packet has not been confirmed within a predetermined time, said first judging means judges that the reception of the connect packet has failed.

5. The receiving device as set forth in claim 1, wherein:
the connect packet includes (i) a data portion containing data necessary for establishing the communication connection, and (ii) an additional portion; and
when the reception of the data portion has been detected, but the reception of the additional portion has failed, said first judging means judges that the reception of the connect packet has failed.

6. The receiving device as set forth in claim 1, further comprising:
plural kinds of the first reception failure patterns;
a notice information table which stores the notice information determined in advance for each of the first reception failure patterns; and
notice information read-out means for, when said first judging means judges that the reception of the connect packet has failed, (i) specifying the first reception failure pattern that the reception status satisfies and (ii) reading out from the notice information table the notice information corresponding to the specified first reception failure pattern,
said notice information output means outputting to the user interface the notice information read out by said notice information read-out means.

7. A receiving device which receives, using wireless communication, from a transmitting device (i) a connect packet for establishing a communication connection and (ii) a data packet which contains transfer data and whose communication speed is higher than that of the connect packet, the receiving device comprising:
first judging means for judging, depending on whether or not a reception status satisfies a predetermined first reception failure pattern, whether a reception of the connect packet has succeeded or failed;
second judging means for judging, depending on whether or not the reception status satisfies a predetermined second reception failure pattern, whether a reception of the data packet has succeeded or failed; and
notice information output means for, when said first judging means judges that the reception of the connect packet has succeeded and said second judging means judges that the reception of the data packet has failed, outputting notice information, for prompting a user to avoid the reception failure of the data packet, to a user interface.

8. The receiving device as set forth in claim 7, further comprising
second pulse detecting means for detecting a second pulse corresponding to the communication speed of the data packet,
wherein, when said second pulse detecting means has detected a predetermined number of the second pulses, but the reception of the data packet has not been confirmed, said second judging means judges that the reception of the data packet has failed.

9. The receiving device as set forth in claim 7, further comprising
communication speed detecting means for detecting the communication speed of the data packet,
wherein, when said communication speed detecting means detects the data packet whose communication speed is higher than that of the connect packet received successfully, said second judging means judges that the reception of the data packet has failed.

10. The receiving device as set forth in claim 7, wherein:
an error-detecting code is added to the data packet; and
when the error rate, detected by using the error-detecting code, of received data is a predetermined threshold value or higher, said second judging means judges that the reception of the data packet has failed.

11. The receiving device as set forth in claim 10, wherein:
the wireless communication is infrared communication; and
the threshold value is 1×10⁻⁸.

12. The receiving device as set forth in claim 7, wherein:
there are a plurality of the data packets;
sequence numbers, indicating orders, are given to the data packets, respectively; and
when the data packet corresponding to the sequence number indicating a beginning has not been received, said second judging means judges that the reception of the data packets has failed.

13. The receiving device as set forth in claim 7, wherein:
there are a plurality of the data packets;
sequence numbers, indicating orders, are given to the data packets, respectively; and
when the data packet corresponding to the sequence number indicating an ending has not been received, or when the data packet, whose one field indicating whether or not the data packet is a last one indicates that the data packet is the last one, has not been received, said second judging means judges that the reception of the data packets has failed.

14. The receiving device as set forth in claim 7, wherein:
there are a plurality of the data packets;
sequence numbers, indicating orders, are given to the data packets, respectively; and
when the data packet corresponding to the sequence number indicating a beginning and the data packet corresponding to the sequence number indicating an ending have been received, but the data packet corresponding to an intermediate sequence number has not been received, said second judging means judges that the reception of the data packets has failed.

15. The receiving device as set forth in claim 7, wherein:
there are a plurality of the data packets;
sequence numbers, indicating orders, are given to the data packets, respectively; and
when the data packet corresponding to the sequence number indicating a beginning and the data packet corresponding to the sequence number indicating an ending have been received, but only the data packets corresponding to consecutive intermediate sequence numbers have not been received, said second judging means judges that the reception of the data packets has failed.

16. The receiving device as set forth in claim 7, wherein:
there are a plurality of the data packets;
sequence numbers, indicating orders, are given to the data packets, respectively; and
when the data packet corresponding to at least one of the sequence numbers has not been received, said second judging means judges that the reception of the data packets has failed.

17. The receiving device as set forth in claim 7, further comprising:
plural kinds of the second reception failure patterns;
a notice information table which stores the notice information determined in advance for each of the second reception failure patterns; and
notice information read-out means for, when said second judging means judges that the reception of the data packet has failed, (i) specifying the second reception failure pattern that the reception status satisfies and (ii) reading out from the notice information table the notice information corresponding to the specified second reception failure pattern,
said notice information output means outputting to the user interface the notice information read out by said notice information read-out means.

18. The receiving device as set forth in claim 1, wherein
the notice information is cause information indicating a cause of the reception failure.

19. The receiving device as set forth in claim 1, wherein
the notice information is solution information indicating a solution to the reception failure.

20. The receiving device as set forth in claim 1, wherein
the wireless communication is infrared communication.

21. The receiving device as set forth in claim 20, wherein:
the communication speed of the connect packet is 9,600 bps; and
the communication speed of the data packet is 4 Mbps.

22. An electronic apparatus comprising:
a receiving device which receives, using wireless communication, from a transmitting device (i) a connect packet for establishing a communication connection and (ii) a data packet which contains transfer data and whose communication speed is higher than that of the connect packet, the receiving device including: first judging means for judging, when a reception status satisfies a predetermined first reception failure pattern, that a reception of the connect packet has failed; and notice information output means for, when said first judging means judges that a reception failure has occurred, outputting notice information, for prompting a user to avoid the reception failure, to a user interface; and
the user interface to which said notice information output means of the receiving device outputs the notice information.

23. The electronic apparatus as set forth in claim 22, being an image displaying apparatus which displays data received from the transmitting device.

24. The electronic apparatus as set forth in claim 22, being a recording apparatus which records data received from the transmitting device.

25. The electronic apparatus as set forth in claim 22, being a printing apparatus which prints out data received from the transmitting device.

26. The electronic apparatus as set forth in claim 22,
wherein the wireless communication is infrared communication,
the electronic apparatus further comprising:
an infrared receiving section which receives infrared; and
light receiving location informing means for informing a user of a location of the infrared receiving section.

27. The electronic apparatus as set forth in claim 26, being an image displaying apparatus which displays data received from the transmitting device, wherein
said light receiving location informing means causes a display screen to display the location of the infrared receiving section.

28. The electronic apparatus as set forth in claim 23, wherein
the user interface is a display section.

29. A communication method used in a receiving device which receives, using wireless communication, from a transmitting device (i) a connect packet for establishing a communication connection and (ii) a data packet which contains transfer data and whose communication speed is higher than that of the connect packet, the communication method comprising the steps of:
(i) judging by first judging means of the receiving device, when a reception status satisfies a predetermined first reception failure pattern, that a reception of the connect packet has failed; and
(ii) when said first judging means judges that the reception failure has occurred, outputting notice information, for prompting a user to avoid the reception failure, to a user interface by notice information output means of the receiving device.

30. A communication method used in a receiving device which receives, using wireless communication, from a transmitting device (i) a connect packet for establishing a communication connection and (ii) a data packet which contains transfer data and whose communication speed is higher than that of the connect packet, the communication method comprising the steps of:
(i) judging by first judging means of the receiving device, depending on whether or not a reception status satisfies a predetermined first reception failure pattern, whether a reception of the connect packet has succeeded or failed;
(ii) judging by second judging means of the receiving device, depending on whether or not the reception status satisfies a predetermined second reception failure pattern, whether a reception of the data packet has succeeded or failed; and
(iii) when said first judging means judges that the reception of the connect packet has succeeded and said second judging means judges that the reception of the data packet has failed, outputting notice information, for prompting a user to avoid the reception failure of the data packet, to a user interface by notice information output means of the receiving device.

31. A receiving device control program causing a receiving device to operate, the receiving device receiving, using wireless communication, from a transmitting device (i) a connect packet for establishing a communication connection and (ii) a data packet which contains transfer data and whose communication speed is higher than that of the connect packet,
the receiving device control program causing a computer to function as:
first judging means for judging, when a reception status satisfies a predetermined first reception failure pattern, that a reception of the connect packet has failed; and
notice information output means for, when said first judging means judges that a reception failure has occurred, outputting notice information, for prompting a user to avoid the reception failure, to a user interface.

32. A computer-readable recording medium recording a receiving device control program causing a receiving device to operate, the receiving device receiving, using wireless communication, from a transmitting device (i) a connect packet for establishing a communication connection and (ii) a data packet which contains transfer data and whose communication speed is higher than that of the connect packet,
the computer-readable recording medium recording the receiving device control program causing a computer to function as:
first judging means for judging, when a reception status satisfies a predetermined first reception failure pattern, that a reception of the connect packet has failed; and
notice information output means for, when said first judging means judges that a reception failure has occurred, outputting notice information, for prompting a user to avoid the reception failure, to a user interface.

33. A computer data signal containing a receiving device control program causing a receiving device to operate, the receiving device receiving, using wireless communication, from a transmitting device (i) a connect packet for establishing a communication connection and (ii) a data packet which contains transfer data and whose communication speed is higher than that of the connect packet,
the receiving device control program causing a computer to function as:
first judging means for judging, when a reception status satisfies a predetermined first reception failure pattern, that a reception of the connect packet has failed; and
notice information output means for, when said first judging means judges that a reception failure has occurred, outputting notice information, for prompting a user to avoid the reception failure, to a user interface.
